(19) United States
(12) Patent Application Publication
(10) Pub. No.: US 2020/0360239 A1
(43) Pub. Date: Nov. 19, 2020

(54) DISPENSER DEVICES AND METHODS

(71) Applicants: Eric Franquez Campos, Fullerton, CA (US); Jennifer Michelle Devine, Salinas, CA (US)

(72) Inventors: Eric Franquez Campos, Fullerton, CA (US); Jennifer Michelle Devine, Salinas, CA (US)

(21) Appl. No.: 16/712,264

(22) Filed: Dec. 12, 2019

Related U.S. Application Data
(63) Continuation-in-part of application No. 29/690,976, filed on May 13, 2019.

(51) Int. Cl. A61J 7/00

(52) U.S. Cl. CPC A61J 7/0053

(57) ABSTRACT

Dispenser devices and methods for dispensing an amount of a preparation involve the use of a control assembly, a viewing assembly, a vial assembly, and a dispenser tip. The vial assembly can be at least partially housed by the viewing assembly, the dispenser tip can be coupled with a vial of the vial assembly, and a distal nozzle of the dispenser tip can extend distally from a distal aperture of the vial. An interference fit can be present between the vial and the dispenser tip, and the viewing assembly and the control assembly can be coupled together and cooperate to inhibit the dispenser tip and the vial from uncoupling from one another.

### CROSS-REFERENCES TO RELATED APPLICATIONS

This application is a continuation-in-part of application Ser. No. 29/690,976 filed May 13, 2019, the content of which is incorporated herein by reference.

### BACKGROUND OF THE INVENTION

Dispenser devices are used to dispense any of a variety of materials to a user. Commonly known dispenser devices include vaping devices, which for example can be operated to deliver Cannabis and other plant preparations to a user. Although these devices can be helpful in providing users with delivered amounts of such preparations, still further improvements are desired. Embodiments of the present invention provide solutions to at least some of these outstanding needs.

### BRIEF SUMMARY OF THE INVENTION

Embodiments of the present invention encompass systems, devices, and methods for dispensing a preparation for consumption by a patient or individual. In some cases, a preparation may be provided as a fluid. In some cases, a preparation may include a medicament. In some cases, a preparation may include a Cannabis oil, tincture, extract, derivative, and/or constituent. Exemplary devices may be configured to dispense any of a variety of preparations, such as fluids, gels, pastes, liquids, nanoemulsions, and the like. As used herein, the term “preparation” is intended to include flowable materials that can be dispensed using the disclosed devices and methods. In some embodiments, methods, systems, and devices can be used for the oral or sublingual administration of a Cannabis preparation to a user or individual. In some cases, a dispensing device can be provided as a pen-like or pen-shaped device, which is configured to dispense micro-dose amounts of Cannabis constituents and/or other compounds or molecules. In some cases, dispensing devices can be provided as a disposable onetime use device. According to some embodiments, a dispenser device can include two or more function assemblies that together form a full assemblage of a dispenser device. In some cases, a dispenser device can include an actuator assembly, a cartridge and housing assembly, and a cap assembly. In some cases, a dispenser device can be provided as a single chamber mechanical dispenser device configuration.

According to some embodiments, a dispenser device may be provided in a reusable configuration. In some embodiments, a dispenser device may be provided in a disposable configuration. In some instances, a disposable micro-dosing medicament dispensing device can be inexpensively produced. In some cases, a dispenser device can be provided as a pen-shaped device having a cap. Exemplary embodiments enable a user to select a very precise dose using a dial or knob and then dispense the dose by pushing a dispense button which in turn actuates a plunger or stopper.

In one aspect, embodiments of the present invention encompass dispenser devices for dispensing an amount of a preparation. An exemplary dispenser device includes a control assembly, a viewing assembly, a vial assembly, and a dispenser tip. In some cases, a dispenser device includes a cap. The vial assembly may be at least partially housed by the viewing assembly. The dispenser tip can be coupled with a vial of the vial assembly. A distal nozzle of the dispenser tip can extend distally from a distal aperture of the vial. An interference fit can be present between the vial and the dispenser tip. The viewing assembly and the control assembly can be coupled together and cooperate to inhibit the dispenser tip and the vial from uncoupling from one another.

In another aspect, embodiments of the present invention encompass a dispenser device, where the dispenser device includes a vial assembly, a dispenser tip, a viewing assembly, a control assembly, and a cap. The vial assembly can include a vial, a stopper, and a preparation. The stopper and the preparation can be are disposed within the vial. The vial can include a proximal portion and a distal portion. The dispenser tip can have a proximal portion and a distal portion. The proximal portion of the dispenser tip can be engaged with the distal portion of the vial. The viewing assembly can include a viewing assembly coupling mechanism. The control assembly can include a control assembly coupling mechanism and a dosage knob. The control assembly coupling mechanism can be coupled with the viewing assembly coupling mechanism. The dosage knob can be configured to set a desired dosage amount of the preparation for dispensing by the dispenser device. The cap can be configured to releasably attach with the viewing assembly. The proximal portion of the vial can contact the control assembly at a first contact location, the distal portion of the dispenser tip can contact the viewing assembly at a second contact location, and compression created at the first contact location and the second contact location due to engagement between the control assembly and the viewing assembly can inhibit disengagement between the proximal portion of the dispenser tip and the distal portion of the vial. The distal portion of the vial can include a rim having an outer surface, an inner surface, a distal surface disposed between the outer surface and the inner surface, and a distal aperture. The proximal portion of the dispenser tip can include a flange proximal portion inner surface, a proximal shaft having a proximal shaft surface, and a flange distal portion inner surface disposed between the flange proximal portion inner surface and the proximal shaft surface. The outer surface of the rim of the vial can be apposed to the flange proximal portion inner surface of the proximal portion of the dispenser tip, the inner surface of the rim of the vial can be apposed to the proximal shaft surface of the proximal portion of the dispenser tip, the distal surface of the rim of the vial can be apposed to the flange distal portion inner surface of the proximal portion of the dispenser tip, and the distal aperture of the rim of the vial can be configured to receive the proximal shaft of the dispenser tip.

In some cases, the proximal portion of the dispenser tip includes a proximal body surface, the distal portion of the dispenser tip includes a distal nozzle surface, the dispenser tip includes a distal shaft surface disposed between the proximal body surface and the distal nozzle surface, and a circumference of the distal shaft surface is less than a circumference of the proximal body surface and greater than a circumference of the distal nozzle surface.

In still another aspect, embodiments of the present invention encompass a dispenser device, where the dispenser device includes a vial assembly, a dispenser tip, a viewing assembly, a control assembly, and optionally, a cap configured to releasably attach with the viewing assembly. A vial assembly may include a vial, a stopper, and a preparation. The stopper and the preparation can be disposed within the vial, and the vial can have a proximal portion and a distal portion. The dispenser tip can have a proximal portion and a distal portion. The proximal portion of the dispenser tip can be engaged with the distal portion of the vial and an interference fit can be present between the proximal portion of the dispenser tip and the distal portion of the vial. The viewing assembly can have a viewing assembly coupling mechanism. The control assembly can have a control assembly coupling mechanism and a dosage knob. The control assembly coupling mechanism can be coupled with the viewing assembly coupling mechanism. The dosage knob can be configured to set a desired dosage amount of the preparation for dispensing by the dispenser device. The proximal portion of the vial can contact the control assembly at a first contact location, the distal portion of the dispenser tip can contact the viewing assembly at a second contact location, and compression created at the first contact location and the second contact location due to engagement between the control assembly and the viewing assembly can inhibit disengagement between the proximal portion of the dispenser tip and the distal portion of the vial. The distal portion of the vial can have a rim, the proximal portion of the dispenser tip can have a groove defined at least in part by a flange of the proximal portion of the dispenser tip and a proximal shaft of the proximal portion of the dispenser tip, and the rim of the distal portion of the vial can be received by the groove of the proximal portion of the dispenser tip. The flange can have a proximal portion with a proximal edge, the proximal shaft can have a proximal edge, and the proximal edge of the proximal shaft can be disposed proximal to the proximal edge of the proximal portion of the flange.

In a further aspect, embodiments of the present invention encompass a dispenser device, where the dispenser device includes a vial assembly, a dispenser tip, a viewing assembly, and a control assembly. The vial assembly can have a vial, a stopper, and a preparation. The stopper and the preparation can be disposed within the vial, and the vial can have a proximal portion and a distal portion. The dispenser tip can have a proximal portion and a distal portion, and the proximal portion of the dispenser tip can be engaged with the distal portion of the vial. The viewing assembly can have a viewing assembly coupling mechanism. The control assembly can have control assembly coupling mechanism and a dosage knob. The control assembly coupling mechanism can be coupled with the viewing assembly coupling mechanism. The dosage knob can be configured to set a desired dosage amount of the preparation for dispensing by the dispenser device. The proximal portion of the vial can contact the control assembly at a first contact location, the distal portion of the dispenser tip can contact the viewing assembly at a second contact location, and compression created at the first contact location and the second contact location due to engagement between the control assembly and the viewing assembly can inhibit disengagement between the proximal portion of the dispenser tip and the distal portion of the vial. In some cases, a dispenser device includes a cap configured to releasably attach with the viewing assembly. In some cases, the distal portion of the vial includes a rim, the proximal portion of the dispenser tip includes a groove, and the rim of the distal portion of the vial can be received by the groove of the proximal portion of the dispenser tip. In some cases, the distal portion of the vial includes a rim having an outer surface, the proximal portion of the dispenser tip includes a flange proximal portion inner surface, and the outer surface of the rim of the vial is apposed to the flange proximal portion inner surface of the proximal portion of the dispenser tip. In some cases, the distal portion of the vial includes a rim having an inner surface, the proximal portion of the dispenser tip includes a proximal shaft surface, and the inner surface of the rim of the vial is apposed to the proximal shaft surface of the proximal portion of the dispenser tip. In some cases, the distal portion of the vial includes a rim having a distal surface, the proximal portion of the dispenser tip includes a flange distal portion inner surface, and the distal surface of the rim of the vial is apposed to the flange distal portion inner surface of the proximal portion of the dispenser tip. In some cases, the distal portion of the vial includes a rim having a distal aperture, the proximal portion of the dispenser tip includes a proximal shaft, and the distal aperture of the rim of the vial is configured to receive the proximal shaft of the dispenser tip. In some cases, the proximal portion of the dispenser tip includes a proximal shaft having a vial port opening, the distal portion of the dispenser tip includes a distal nozzle having a distal exit port, and the vial port opening of the proximal shaft of the proximal portion of the dispenser tip is in fluid communication with the distal exit port of the distal nozzle of the distal portion of the dispenser tip. In some cases, the proximal portion of the dispenser tip includes a proximal body surface, the distal portion of the dispenser tip includes a distal nozzle surface, the dispenser tip includes a distal shaft surface disposed between the proximal body surface and the distal nozzle surface, and a circumference of the distal shaft surface is less than a circumference of the proximal body surface and greater than a circumference of the distal nozzle surface. In some cases, the dispenser tip includes a transition surface disposed between the distal nozzle surface and the distal shaft surface. In some cases, the proximal portion of the dispenser tip includes a flange having a proximal portion with a proximal edge, the proximal portion of the dispenser tip includes a proximal shaft having a proximal edge, and the proximal edge of the proximal shaft is disposed proximal to the proximal edge of the proximal portion of the flange. In some cases, a diameter of the proximal edge of the proximal shaft is less than a diameter of the proximal edge of the proximal portion of the flange. In some cases, the proximal portion of the dispenser tip includes a proximal port, the distal portion of the dispenser tip includes a distal port, and the dispenser tip includes a central longitudinal conduit extending between the proximal port of the proximal portion of the dispenser tip and the distal port of the distal portion of the dispenser tip. In some cases, an inner diameter of the distal port of the distal portion of the dispenser tip is less than an inner diameter of the proximal port of the proximal portion of the dispenser tip. In some cases, the distal portion of the dispenser tip includes a distal nozzle, the viewing assembly includes a distal aperture, and the distal nozzle of the dispenser tip extends distally through the distal aperture of the viewing assembly. In some cases, the viewing assembly coupling mechanism includes a threaded section, the control assembly coupling mechanism includes a threaded section, and the threaded section of the viewing assembly coupling mechanism is configured to threadingly engage the threaded section of the control assembly coupling mechanism. In some cases, the viewing assembly coupling mechanism includes a tab, the control assembly coupling mechanism includes an indent, and the indent of the control assembly coupling mechanism is configured to receive the tab of the viewing assembly coupling mechanism. In some cases, the viewing assembly coupling mechanism includes an aperture, the control assembly coupling mechanism includes a tab, and the aperture of the viewing assembly coupling mechanism is configured to receive the tab of the control assembly coupling mechanism. In some cases, the viewing assembly comprises one or more sight windows.

In another aspect, embodiments of the present invention encompass a micro-dosing dispenser device that includes a dispenser tip or pressure-fitting tip assembly and a vial containing a medicament, and the dispenser tip has a shaft (e.g. a cone-shaped shaft) that seals the vial as the dispenser tip snaps onto the vial. In some cases, a vial, a stopper (e.g. a rubber or silicone stopper), and a dispenser tip can be configured to fit inside of a viewing assembly or vial holder, and the viewing assembly can be configured to snap together with a control assembly or main body of the dispenser device, to create a leak-proof, water-tight seal between the dispenser tip and the vial. In some cases, the dispenser tip and the vial can seal with a silicone gasket. In some cases, the dispenser tip has a cone-shaped tip. In some cases, the vial is made of a hard plastic material. In some cases, the vial has a distal rim or lock tip that can be configured for sealing by a dispenser tip. In some cases, dispenser tips can be provided in a variety of different sizes, and different sizes can be used with corresponding preparations having different viscosities. In some cases, a dispenser device may be configured to be disposable, after a desired amount of preparation has been dispensed from a single vial.

In some cases, a dispenser device can be configured to be reusable, and after a desired amount of preparation has been dispenses from a single vial, the used vial can be removed from the dispenser device and replaced with a new vial that is loaded with a Cannabis preparation. In some cases, a dispenser device can be configured for use in dispensing an amount of preparation without requiring the use of a needle (e.g. tissue-piercing injection needle). In some cases, a dispenser device can be configured for use in dispensing a liquid or paste by expelling the liquid or paste in fixed amounts that are measured and are repeatable. An exemplary dispenser device may include an exterior housing having one or more component parts. A dispenser device may also include a serviceable cartridge or vial assembly. A vial assembly may include a vial, a displaceable stopper disposed within the vial, and an amount of preparation contained within the vial. A vial may be coupled with a dispenser tip. In some cases, a housing component may include a viewing assembly configured to receive a cartridge or vial. In some cases, a housing component may include a control assembly, which may include mechanical and/or electronic mechanisms for providing motive force for the displacement of a stopper within a vial. In some cases, the viewing assembly and control assembly can be configured to be attachable with one another, and to be detachable from one another. For example, the viewing assembly and control assembly can be coupled via a threaded engagement, a snap-on engagement, or the like. In some cases, a dispenser device includes a protective cap. In some cases, a cap may include a clip that can be attached with a clothing garment. In some cases, a vial assembly can be provided as a refillable vial assembly. In some cases, a vial assembly can be provided as a replaceable vial assembly. In some cases, a control assembly may include a presetting mechanism that allows a user to preset an amount of preparation (e.g. fluid, liquid, paste, gel, or the like) to be dispensed by the dispenser device. In some cases, a control assembly may include an initiating mechanism that allows a user to initiate the dispensing of an amount of preparation (e.g. fluid, liquid, paste, gel, or the like) from the dispenser device. In some cases, an initiating mechanism may be a dispense button. In some cases, a dispenser device can include a communication and/or control mechanism whereby a user can communicate with and/or control the device via radio, inductive, or light signals, devices, or energy.

In still another aspect, embodiments of the present invention encompass disposable dispenser device. A dispenser device can be configured to be disposable, after a desired amount of preparation has been dispenses from a single vial. In some cases, a dispenser device can be configured for use in dispensing an amount of preparation without requiring the use of a needle (e.g. tissue-piercing injection needle). In some cases, a dispenser device can be configured for use in dispensing a liquid or paste by expelling the liquid or paste in fixed amounts that are measured and are repeatable. An exemplary dispenser device may include an exterior housing having one or more component parts. A dispenser device may also include a serviceable cartridge or vial assembly. A vial assembly may include a vial, a displaceable stopper disposed within the vial, and an amount of preparation contained within the vial. A vial may be coupled with a dispenser tip. In some cases, a housing component may include a viewing assembly configured to house a cartridge or vial. In some cases, a housing component may include a control assembly, which may include mechanical and/or electronic mechanisms for providing motive force for the displacement of a stopper within a vial. In some cases, the viewing assembly and control assembly can be configured to be attachable with one another, and to be detachable from one another. For example, the viewing assembly and control assembly can be coupled via a threaded engagement, a snap-on engagement, or the like. In some cases, a dispenser device includes a protective cap. In some cases, a cap may include a clip that can be attached with a clothing garment. In some cases, a vial assembly can be provided as a single-use vial assembly. In some cases, a control assembly may include a presetting mechanism that allows a user to preset an amount of preparation (e.g. fluid, liquid, paste, gel, or the like) to be dispensed by the dispenser device. In some cases, a control assembly may include an initiating mechanism that allows a user to initiate the dispensing of an amount of preparation (e.g. fluid, liquid, paste, gel, or the like) from the dispenser device. In some cases, an initiating mechanism may be a dispense button. In some cases, a dispenser device can include a communication and/or control mechanism whereby a user can communicate with and/or control the device via radio, inductive, or light signals, devices, or energy.

### BRIEF DESCRIPTION OF THE DRAWINGS

FIG. 1 depicts aspects of a dispenser device, according to embodiments of the present invention.

FIG. 2 illustrates aspects of a dispenser device, according to embodiments of the present invention.

FIG. 3 illustrates aspects of a dispenser device, according to embodiments of the present invention.

FIG. 4 depicts aspects of a dispenser device, according to embodiments of the present invention.

FIGS. 5A, 5B, and 5C show aspects of a dispenser device, according to embodiments of the present invention.

FIG. 6 shows aspects of a dispenser device, according to embodiments of the present invention.

FIG. 7 depicts aspects of a control assembly for a dispenser device, according to embodiments of the present invention.

FIGS. 8A, 8B, and 8C illustrate aspects of a vial for a dispenser device, according to embodiments of the present invention.

FIG. 8D depicts aspects of a dispenser tip for a dispenser device, according to embodiments of the present invention.

FIGS. 8E-1, 8E-2, and 8E-3 illustrate aspects of a viewing assembly for a dispenser device, according to embodiments of the present invention.

FIGS. 8F-1, 8F-2, and 8F-3 illustrate aspects of a viewing assembly for a dispenser device, according to embodiments of the present invention.

FIGS. 8G-1, 8G-2, and 8G-3 illustrate aspects of a viewing assembly for a dispenser device, according to embodiments of the present invention.

FIGS. 9A to 9G show aspects of a dispenser tip for a dispenser device, according to embodiments of the present invention.

FIGS. 10A, 10B, and 10C show aspects of a dispenser device, according to embodiments of the present invention.

FIG. 10D depicts aspects of a viewing assembly for a dispenser device, according to embodiments of the present invention.

FIGS. 10E-1 and 10E-2 depict aspects of a dispenser tip for a dispenser device, according to embodiments of the present invention.

FIG. 11 depicts aspects of a dispenser device, according to embodiments of the present invention.

FIGS. 12A to 12G illustrate aspects of a viewing assembly for a dispenser device, according to embodiments of the present invention.

FIGS. 13A to 13G illustrate aspects of a viewing assembly for a dispenser device, according to embodiments of the present invention.

### DETAILED DESCRIPTION OF THE INVENTION

Embodiments of the present invention encompass systems, devices, and methods for dispensing or administering a precise, customized dose of a preparation or another desired material. Exemplary devices provide the user to select the dosage amount to be dispensed, thus providing the user with reliable control over the outcome of a micro-dosed administration, which may occur in the user themselves, or in another individual such as a patient or consumer. In some embodiments, a device includes a hollow spout for the delivery or dispensing of a preparation, which may include a liquid compound, for example. In some embodiments, a device can include a dose setting and dispensing mechanism that allows the user to control the device in a simple and efficient manner. In some cases, an individual can operate a dispenser device to deliver an amount of a preparation into their own mouth or into another person's mouth, so as to provide an oral or sublingual administration of the preparation. In some cases, an individual can operate a dispenser device to deliver an amount of a preparation into a cup or a container, and then the individual or another person can consume the preparation from the cup or container, so as to provide an oral or sublingual administration of the preparation.

Dispenser device and method embodiments disclosed herein may provide advantages over other delivery modalities, such as vaping, standard tincture droppers, edibles, and the like. Vaping may be inconvenient for public consumption. Standard tincture droppers for sublingual administration may provide uneven or inconsistent drop distributions. Edibles are typically provided in pre-defined amounts (e.g. 2.5 mg dose) which cannot conveniently be subdivided for the administration of smaller dosage amounts. Dispenser device and method embodiments disclosed herein can provide precise and consistent dosages, in any desired amount, in a repeatable fashion, every time. Dispenser device and method embodiments disclosed herein can also provide for the ingestion of whole plant Cannabis oils and tinctures. Dispenser device and method embodiments disclosed herein can provide a user with a discrete and convenient delivery modality which can be carried in a purse or pocket.

Exemplary disposable dispenser devices can be configured to include vials having a 3 milliliter capacity, and to provide a dosing capacity of 0.1mg to 2.5 mg of Cannabis preparation or constituent(s) per dose or a dispensed fixed-amount. Disposable dispenser devices can be configured to dispense sublingually or into any beverage using a water-soluble Cannabis extracted oil formulation.

Exemplary reusable dispenser devices can be configured to include vials having a 3 milliliter capacity, and to provide a dosing capacity of 0.1mg to 2.5 mg of Cannabis preparation or constituent(s) per dose or a dispensed fixed-amount. Reusable dispenser devices can be configured to dispense sublingually or into any beverage using a water-soluble Cannabis extracted oil formulation.

Dispenser devices and methods as disclosed herein are well suited for use in dispensing small amounts of preparations such as liquids, pastes, fluids, and other materials, often measured in small portions of milliliters. Exemplary preparations may include lubricating oils, liquid medicaments, a liquid catalyst, water, liquid glue, liquid dye, or indeed any liquid with appropriate viscosity. In particular, a dispenser device can be used to deliver a measured quantity of a preparation, such as a medicament, into a drink or food that will be consumed by the user. In some instances, it is desirable to mix a preparation (which may include one or more Cannabis constituents) into a glass of water, coffee, soda, or the like before consumption. In some cases, a preparation may benefit from being combined with another fluid such as a beverage, because the preparation (e.g. containing an oil-based vitamin) may have a bad or sour taste if consumed directly. Exemplary dispenser devices and methods disclosed herein can be used to accurately measure and dispense lubricating oil onto a mechanical mechanism to aid in its smooth function and preservation. In many such applications of lubricating oil it may be imperative that the oil not migrate over time beyond the mechanism, thus the need to dispense only by precise means.

According to some embodiments of the present invention, a dispenser device can be used to deliver one or more doses of a preparation (e.g. containing one or more medicamental or Cannabis oils) into a drink, whereby the user can mask an unpleasant or undesirable taste of the medicament. In some cases, a dispenser device can be used for the dosing of medicamental or Cannabis oils. In some cases, a dispenser device can be used to deliver any desired formulary of a medicament or preparation, in order to provide maximum benefit or desired effect to the user. Dispenser devices can be used to deliver precisely measured doses, in a repeatable and reliable manner, with little need for the user to manipulate or measure the medicament itself. In some cases, a dispenser device does not include a needle, an internal or external spike, or a barb.

In some cases, a dispenser device is therefore safer than a syringe. In some cases, a dispenser device is portable, socially acceptable when carried in the open pocket of a shirt, protected from accidental disassembly, and easily adjustable to be set to deliver one of several preset dose amounts without fuss by the user. Exemplary dispenser devices can be used to deliver repeatable and precise dosing of medicaments or preparations upon demand. Embodiments of the present invention encompass dispenser devices that do not leak liquids (e.g. from a vial and/or a dispenser tip), even when a cap is not present on the dispenser device. Exemplary dispenser devices do not require the replacement in installation of a needle or a similar consumable component, prior to the dispensing of a preparation or liquid.

According to some embodiments, a dispenser device can be provided as a small portable device that delivers small pre-measured amounts of a preparation or liquid, not for injection, using a method that is accurate and repeatable, and does not employ an internal or external spike, barb, or needle (e.g. tissue-penetrating features, such as a standard tissue penetrating hypodermic needle) that can injure a user.

Embodiments of the present invention encompass dispenser devices and methods for use in effecting the controlled and measured dispensing of preparations or liquids, such as a dose of a medicament or preparation to food or drink. In some cases, a dispenser device can be used to dispense oils. In some cases, a dispenser device can have the appearance and form-factor of a pen, perhaps similar in size and shape of a high-quality fountain pen. In some cases, dispenser devices can include disposable cartridges or vials that can hold medicaments of differing formulations. In some cases, dispenser devices can employ cartridges or vials without the need of a foil or paper seals that must be pierced by a pin or needle before prior to, or upon or during, the installation of the cartridge into the device.

According to some embodiments, a vial, cartridge, and/or dispenser device can be configured so that a partially used cartridge or vial may be removed and stored safely and cleanly, while another cartridge or vial is installed and used. In some cases, a vial or cartridge may operate to contain the contents therein (e.g. an amount of a preparation) without requiring a seal.

According to some embodiments, the term “fixed amount” as used herein may refer to an amount of a preparation, which may be for example a lubricating oil, a paint, a glue, a catalyst, another chemical, a dose of medicament or one or more Cannabis constituents.

These and other advantages will become evident from the following more detailed description of embodiments of the invention.

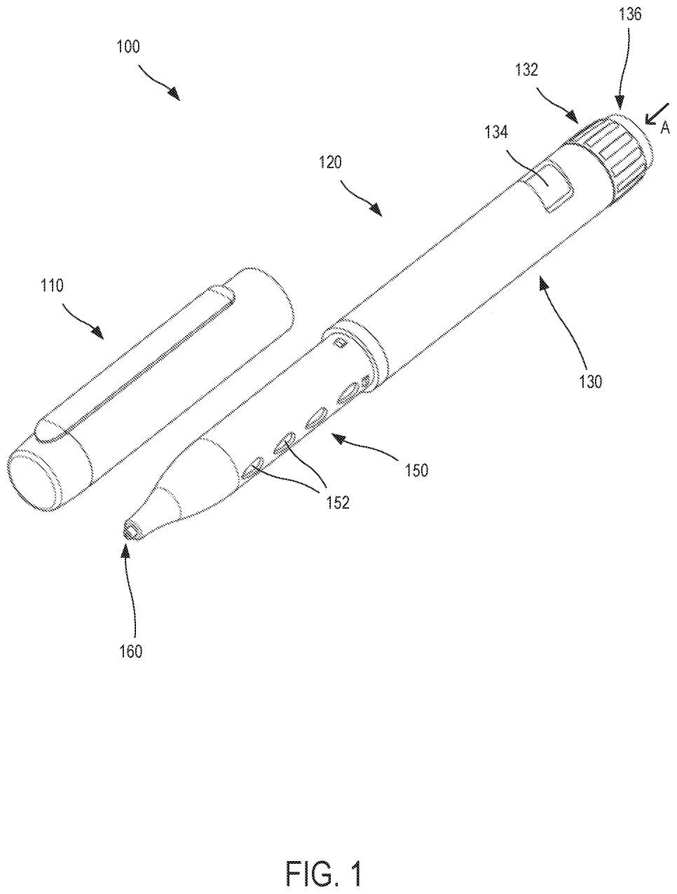

Turning now to the drawings, FIG. 1 depicts a dispenser device 100 according to embodiments of the present invention. As shown here, dispenser device 100 includes a cap 110 and a main body 120. The main body 120 includes a control assembly 130, a vial assembly (not shown), a viewing assembly 150, and a dispenser tip 160. In this illustration, the cap 110 is removed from the main body 120. Control assembly 130 includes a dosage knob 132, a dosage window 134, and a dispense button 136. During operation of the dispenser device 100, the user can look at or through the dosage window 134 to see markings imprinted on a subassembly within the main body 120 that rotates with the turning of the dosage knob 132. As the dosage knob 132 is rotated, a mechanical stop within the main body 120 is set to limit the travel of the fixed-amount dispense button 136 once pressure is applied to said fixed-amount dispense button 136 in the direction indicated by arrow A. Once the fixed-amount has been selected, and the user has positioned the main body 120 at, near, or above where the fixed-amount of material is to be delivered, the user can press on the fixed amount dispense button 136, which will cause the material to be expelled from the dispenser tip 160, until the internal mechanism reaches the mechanical stop, at which time movement of the fixed-amount dispense button 136 will cease, resulting in the exit of the material being dosed also ceasing, indicating to the user that the fixed-amount has been delivered. In this way, the dosage knob 132 can be configured to set a desired dosage amount of a preparation for dispensing by the dispenser device 100.

As shown in FIG. 1, viewing assembly 150 includes one or more material-level sight windows 152. For example, a sight window 152 can have an oval shape. During operation of the dispenser device 100, as a stopper (not shown) travels through the vial (not shown), the user can view the stopper, and the position of the stopper within the vial can provide a visual indication to the user of the approximate amount of material that remains in the vial. The stopper can include a brightly colored material, so as to enhance this visual identification feature. In some cases, dispenser device 100 can be provided as a disposable device. In some embodiments, the viewing assembly 150 depicted here may be referred to as a disposable holder for a vial. A disposable micro-dosing medicament dispenser device can be inexpensively produced. In some cases, dispenser device 100 is provided as a pen-shaped instrument having a cap. As discussed elsewhere herein, a user can select a very precise dose using a dial and then dispense the dose by pushing a plunger or dispense button. The dispenser device can be made out of inexpensive materials. In some cases, dispenser device 100 is configured to be used only once. In some cases, a dispenser device can include a control assembly having a “one-time” dial or dosage knob that rotates in only one direction to provide a single-use embodiment, where the dosage knob does not rotate back in the reverse direction. In some cases, a dispenser device can include a control assembly having a resettable dial or dosage knob, where the dosage knob can rotate back on the reverse direction.

In some cases, a dispenser device can be configured to be controlled by or in communication with a software application or other programming mechanism, whereby the software application or programming mechanism can convert mg (milligrams) of one or more Cannabis constituents or preparations into a corresponding number of clicks or knob rotations of a control assembly, and whereby data can be collected for verifiable analytics. According to some embodiments, a dispenser device can be provided as a single chamber micro-dosing device configured to delivery whole plant cannabis oil and tinctures for oral ingestion. In some cases, a dispenser device can be configured for Bluetooth connectivity, and can be configured to be controlled by or in communication with a controlling dose tracking application.

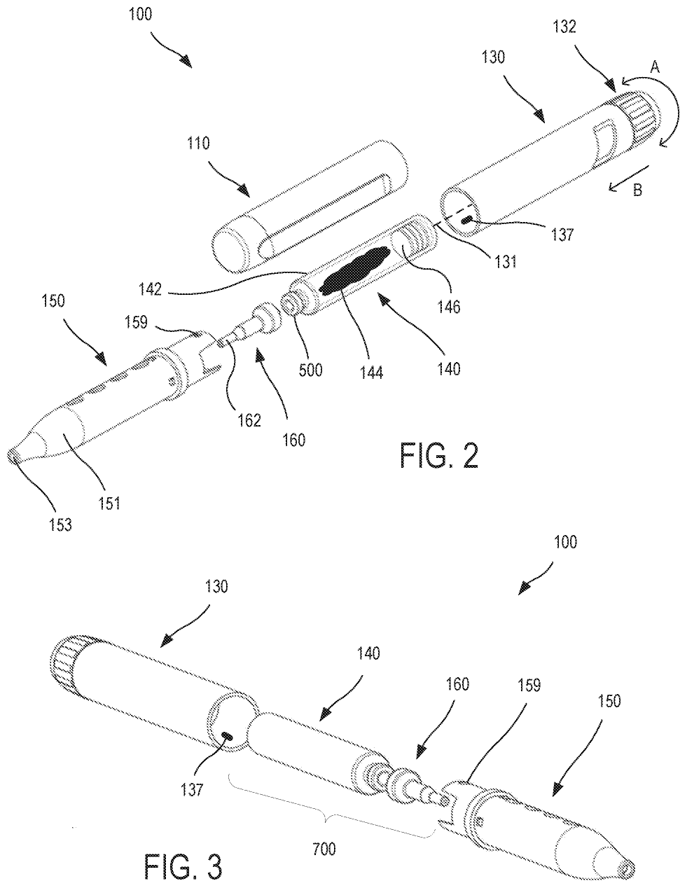

FIG. 2 provides an exploded view of dispenser device 100, which includes cap 110, control assembly 130, vial assembly 140, dispenser tip 160, and viewing assembly 150. In exemplary embodiments, vial assembly 140 includes a vial 142 containing a preparation 144 for dispensing from the dispenser device 100. Vial assembly 140 also includes a stopper 146 that can be positioned within the vial 142. In the embodiment depicted here, vial 142 is made of a transparent material such as glass, so that contents contained within the vial 142 or an interior chamber thereof are visible from outside of the vial. Control assembly 130 includes a dosage knob 132 that can be rotated in a clockwise or counterclockwise fashion, as indicated by arrow A, so as to set the desired amount of preparation 144 to be dispensed from the device 100 in a single actuation of the dosage knob. For example, an actuation of the dosage knob 132 can include pressing the dosage knob 132 so that is translates along a central longitudinal axis 131 of the control assembly 130, in the direction indicated by arrow B, thereby moving a plunger or other actuating mechanism of the control assembly 130 which in turn drives the stopper 146 within the vial 142 from a proximal location within the vial 142 to a more distal location within the vial 142. In some cases, an actuating mechanism, as discussed elsewhere herein, may include a shaft, a piston, a plunger, or the like.

The dosage knob 132 can be rotatable to a set a desired dosage amount, and upon actuation the dosage knob 132 can cause a shaft to move to a position proportional to a set amount of the preparation or a set dose of one or more Cannabis constituents. In this way, the user or operator can configure the dispenser device 100 to dispense a pre-defined amount of a preparation, which contains a pre-defined dose of one or more Cannabis constituents and/or other compounds or molecules, upon actuation of the dosage knob 132, for example by pressing the dosage knob in the direction indicated by arrow B for a pre-defined distance, which may correspond to a single press or “click” of the dosage knob 132. In this way, the dosage knob 132 is translationally moveable, for example to cause the shaft to drive the plunger to push against the stopper 146, thereby driving the stopper 146 within the vial 142 in a distal direction, so as to dispense a precise amount of the preparation 144 from the vial 142. In turn, the amount of preparation 144 is dispensed through the dispenser tip 160 and out of the device 100. In some cases, the stopper 146 can be a rubber stopper. In some cases, the stopper 146 can be a silicone stopper. Other materials can be used in the construction of the stopper 146. In use, the stopper 146 can operate to seal the end of the vial 142 and to dispense an amount of the preparation 144 when pressed upon, for example by a shaft that is coupled with or otherwise in operative association with the dosage knob 132.

As shown in FIG. 2, viewing assembly 150 includes a tapered section 151. As discussed elsewhere herein, tapered section 151 can operate to secure and limit the travel of dispenser tip 160 when the dispenser tip 160 is received by the viewing assembly 150, and a distal nozzle 162 of the dispenser tip 160 extends distally through a distal aperture 153 of the viewing assembly 150. When the dispenser device 100 is being stored or transported, the user can place the cap 100 on the main body (e.g. by engaging cap 100 with viewing assembly 150) so as to protect the distal nozzle 162 and other components of the dispenser device 100 from physical damage.

According to some embodiments, dispenser device 100 is a micro-dosing dispensing device, wherein a dispenser tip 160 (e.g. pressure-fitting tip assembly) attaches to a vial 142 containing a preparation 144 (e.g. medicament). The dispenser tip 160 can have a con-shaped shaft that seals the vial 142 as the dispenser tip 160 snaps onto the vial 142. In some cases, the vial 142, a stopper 146 (e.g. a rubber stopper), and the dispenser tip 160 fit inside a viewing assembly 150 (e.g. vial holder) which snaps together or otherwise couples with the control assembly 130 to create a leak-proof, water-tight seal. In some cases, the dispenser tip 160 and the vial 142 can seal with a silicone gasket. In some cases, the dispenser tip 160 and vial 142 have a cone-shaped tip. In some cases, the vial 142 is fabricated from a hard plastic material. In some cases, the vial assembly 140 (e.g. vial 142 and stopper 146) has a lock tip at the distal end of the vial 142 for easy seal and removal of different size dispenser tips for the use with different viscosities of preparations or medicaments. In some embodiments, the dispenser device 100 is provided as a disposable dispenser device.

According to some embodiments, the term “cartridge subassembly” may refer to the combination of the vial assembly 140 and the dispenser tip 160. In some cases, the cartridge assembly (e.g. cartridge assembly 700 as identified in FIG. 3) operates to hold or contain a liquid, paste, or some other preparation. As discussed elsewhere herein, the vial 142 and dispenser tip 160 can fit and lock together. The stopper 146 can operate to seal a proximal portion of the vial 142. The stopper 146 can be made of thermoplastic, thermoset, polymer, and the like. In some cases, the stopper 146 can be made of rubber, plastic, silicone, or some other material. The stopper 146 can operate to help expel an amount of a preparation 144 from the distal portion of the vial 142 into a proximal portion of the dispenser tip 160 and thereafter out of a distal portion of the dispenser tip. In some cases, a cartridge subassembly can be provided as a replaceable component of the dispenser device 100. In some cases, the cartridge subassembly can be provided as a refillable component of the dispenser device 100.

According to some embodiments, cartridge subassembly 700 can operate to hold or contain a preparation 144 (e.g. a liquid) that can be dispensed by the dispenser device 100 in selectable fixed-amount amounts. In some embodiments, an empty cartridge subassembly 700 includes a vial 142, a dispenser tip 160, and a stopper 146. With the addition of a preparation 144 such as a liquid medicament, the empty cartridge subassembly can become a fully-filled cartridge subassembly. As depicted in FIG. 2, a stopper 146 can be inserted through an open proximal portion of a vial 142. The dispenser tip 160 can be snapped over a distal rim 500 of a vial 142, thereby completing the assembly of the unfilled cartridge subassembly 700.

In some cases, a dispenser device 100 can be manufactured, sold, or otherwise provided as a multiple-use dispenser device. In some cases, the cartridge subassembly 700 can be configured to have the junction of vial 142 and dispenser tip 160 glued or crimped together, or quasi-permanently joined so as to be a single-use device. In some cases, a dispenser device 100 can be configured for use only with a single-use cartridge subassembly 700. In some cases, a dispenser device 100 can be configured for use only with a disposable liquid cartridge subassembly 700. In some cases, a dispenser device 100 can be configured for use as a multiple-use dispenser device that can also use a single-use and disposable cartridge subassembly 700, as well as a cartridge assembly 700 that is sold or otherwise provided to be refillable.

With regard to use of a refillable cartridge subassembly 700, a user who desires to refill the cartridge subassembly 700 can be instructed to: (A) remove the cartridge subassembly 700 from the dispensing device; (B) snap off (or otherwise remove or uncouple) the dispenser tip 160 from the cartridge subassembly 700; (C) use a tool or rod to return the stopper 146 to the proximal portion of the vial 142 (e.g. by moving the stopper 146 from a distal portion of the vial to a proximal portion of the vial); (D) refill vial 142 with a desired preparation 144 (e.g. liquid); (E) replace the dispenser tip 160 onto the vial 142 by snapping the pieces together; and (F) return the cartridge subassembly 700 back into the dispensing device for setup and use. In use, the dispenser device is operated to dispense an amount of preparation from the cartridge subassembly.

As depicted in FIG. 2, a viewing assembly 150 can include a viewing assembly coupling mechanism 159 such as one or more tabs. Such mount-locking tabs 159 can be configured to secure or couple the viewing assembly 150 with the control assembly 130. For example, the control assembly 130 may have a control assembly coupling mechanism 137 such as one or more corresponding indents or apertures, wherein the indents or apertures are configured to receive or otherwise engage the mount-locking tabs 159. In some embodiments, the coupling mechanisms of the viewing assembly and control assembly may be the reverse of what is shown here. For example, a control assembly coupling mechanism may include one or more mount-locking tabs, and a viewing assembly coupling mechanism may include one or more corresponding indents or apertures, wherein the indents or apertures of the viewing assembly coupling mechanism are configured to receive or otherwise engage the mount-locking tabs of the control assembly coupling mechanism.

FIG. 3 provides an exploded view of dispenser device 100, which includes control assembly 130, vial assembly 140, dispenser tip 160, and viewing assembly 150. In some cases, dispenser device 100 is disposable. In some cases, dispenser device is reusable. Dispenser device 100 can include a dose setting and dispensing mechanism (e.g. control assembly 130) to set and effectuate dispensing of a particular dose of a preparation or medicine from a loaded cartridge (e.g. vial assembly 140). In some cases, the dose setting and dispensing mechanism may include a dosage knob, a shaft, and a stopper, as discussed elsewhere herein. The dosage knob may be rotatable to cause the shaft to move to a position proportional to a set dose of the preparation or medicine, and in which the dosage knob or a dispense button is translationally moveable to cause the shaft to drive the stopper to push within the vial to dispense the preparation or medicine from the vial. As discussed elsewhere herein, a viewing assembly 150 may include an integrated spout and snap in tabs which may be inserted into or otherwise engaged with the control assembly 130, which can help to serve as a locking mechanism for liquid/vial content. In some embodiments, dispenser device 100 can be configured to provide a precise leak-free liquid dispensing unit that can be used for precision oral consumption of a preparation such as a medicament or supplement. (oral or container). The mechanism of a stopper of the vial assembly 140 can allow the user to use it one time, for example in a disposable dispenser device configuration. For example, once engaged, the stopper does not return to its original position to re-dispense liquid. Because such a disposable dispenser device is intended to be used only once, one or more components of such a dispenser device can be made out of less expensive materials, such as polycarbonate. Such a less expensive device can allow for cost savings when a dispenser device need not be used more than once.

As depicted in FIG. 3, a viewing assembly 150 can include a viewing assembly coupling mechanism 159 such as one or more tabs. Such mount-locking tabs 159 can be configured to secure or couple the viewing assembly 150 with the control assembly 130. For example, the control assembly 130 may have a control assembly coupling mechanism 137 such as one or more corresponding indents or apertures, wherein the indents or apertures are configured to receive or otherwise engage the mount-locking tabs 159. In some embodiments, the coupling mechanisms of the viewing assembly and control assembly may be the reverse of what is shown here. For example, a control assembly coupling mechanism may include one or more mount-locking tabs, and a viewing assembly coupling mechanism may include one or more corresponding indents or apertures, wherein the indents or apertures of the viewing assembly coupling mechanism are configured to receive or otherwise engage the mount-locking tabs of the control assembly coupling mechanism.

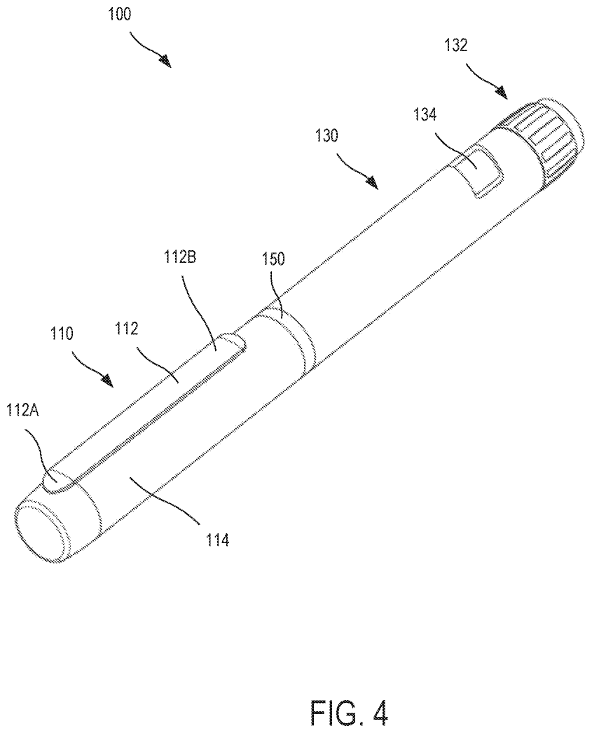

FIG. 4 provides an assembled view of dispenser system 100, which includes cap 110, control assembly 130, and viewing assembly 150. A vial assembly and dispenser tip are hidden from view. In some embodiments, dispenser system 100 is provided as a fully mechanical device. In some embodiments, dispenser system 100 is provided as a partially electronic device. The cap 110 may include or be coupled with a pocket clip 112 that allows a user to clip the dispenser system 100 to a pocket or a strap. Clip 112 can include an elongate arm having one end 112A coupled to the cap body 114 and an opposite free end 112B that cantilevers away from the cap body 114 to create a space for receiving a material thereby clipping the cap 110 to the material. By virtue of this configuration, the dispenser device 100 can be stored in a pocket of a user's garment (e.g. shirt, jacket, pants) in a “tip up” orientation, whereby the exit port of the dispenser tip (not shown) is facing toward the sky.

Dosage knob 132 can be used, for example in conjunction with the dosage window 134, to select a fixed-amount of material to be dispensed by the dispenser system 100. In some embodiments, dosage knob 132 is rotated until the value of the desired fixed-amount is visible in the dosage window 134, then the fixed-amount of material is delivered when the user presses down on the dosage knob 132 or on a dispense button as discussed elsewhere herein.

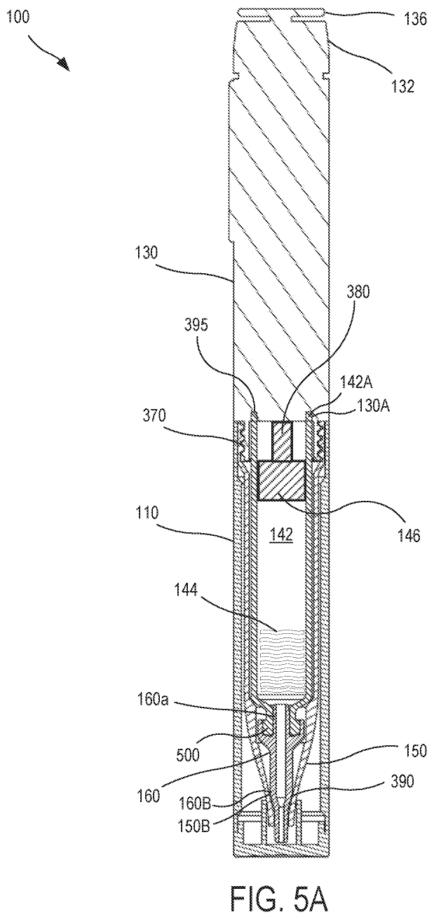

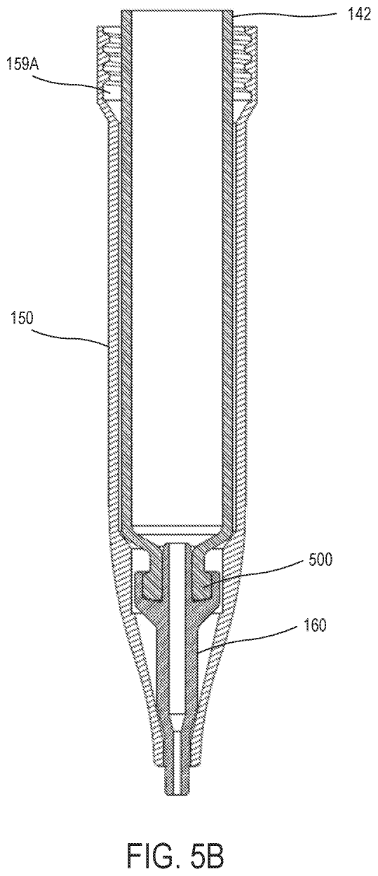

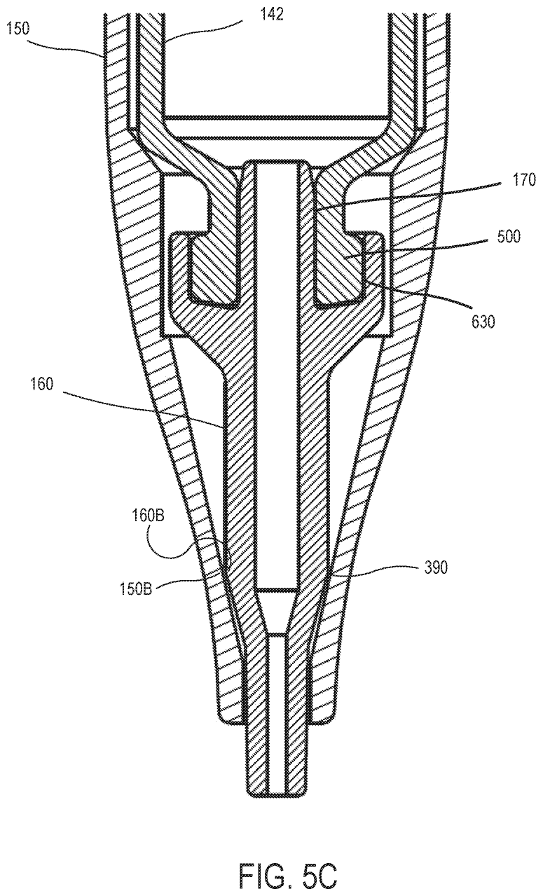

FIG. 5A provides a cross-section view of a dispenser device 100, according to embodiments of the present invention. As shown here, a dispenser device 100 can include a cap 110, a control assembly 130, a vial 142, a viewing assembly 150, and a dispenser tip 160. According to some embodiments, dispenser tip 160 is a pressure-fitting dispenser tip. Dispenser tip attaches with or engages a distal portion of the vial 142. As shown here, the vial 142 can slide into or otherwise be at least partially housed by the viewing assembly 150. In some embodiments, the dispenser tip 160 may have a shaft 160a (which in some cases may be a cone-shaped shaft) at a proximal section of the dispenser tip that penetrates and seals a distal section (e.g. dispensing side) of the vial 142 as the shaft 160a enters a distal opening of the vial 142. In exemplary embodiments, the dispenser tip 160 has a distal section that is blunt shaped, and safer than hypodermic needles that can cause injury.

When considering the vial 142 itself, neither the proximal section nor the distal section may have a seal. When a stopper 146 and a dispenser tip 160 are engaged with the vial 142, these two elements can effectively operate to prevent or inhibit material from exiting the vial 142, until the stopper 146 is activated or otherwise forced in a distal direction toward a distal portion of the vial 142. According to some embodiments, the viewing assembly 150 and control assembly 130, when engaged (e.g. via thread connection 370), can operate to compress dispenser tip 160 and vial 142 together, or otherwise prevent or inhibit dispenser tip 160 and vial 142 from coming apart or disengaging from one another. In this way, operation or coupling of the viewing assembly 150 and control assembly 130 can facilitate a seal between the dispenser tip 160 and vial 142.

As noted above, a dispenser tip can operate to effective seal the distal end of a vial containing a preparation. It has been observed that vial assemblies prepared in this way do not require a physical barrier (e.g. heat shrink seal, or nozzle plug) to prevent the preparation from exiting the distal nozzle of the dispenser tip. The preparation material was observed to remain in the vial, even when the vial assembly and dispenser tip combination was shaken, or stored in an ambient environment. Little or no evaporation from the open distal nozzle of the dispenser tip was observed. Such vial assembly and dispenser tip combinations can be manufactured and sold separately.

According to some embodiments, the viewing assembly 150 can contact the dispenser tip 160 at a contact location or zone 390. For example, a distal portion of the dispenser tip 160 can have an outer contact circumference 160B, a distal portion of the viewing assembly 150 can have an inner contact circumference 150B, and the diameter of the outer contact circumference 160B can be substantially equivalent to the diameter of the inner contact circumference 150B, such that the interface between the outer contact circumference 160B and the inner contact circumference 150B provides a contact location 390. Aspects of these elements are also depicted in FIG. 5C. With returning reference to FIG. 5A, according to some embodiments, the vial 142 can contact the control assembly 130 at a contact location or zone 395. For example, the vial 142 can have a proximal circumferential edge 142A, the control assembly 130 can have a distal-facing annular groove 130A, and the annular groove 130A can be configured to receive the proximal circumferential edge 142A, such that the interface between the circumferential edge 142A and the annular groove 130A provides a contact location 395.

Compression created at contact zone or location 390 and contact zone or location 395 due to engagement between the control assembly 130 and the viewing assembly 150 can help to create or maintain a seal or engagement between the dispenser tip 160 and the vial 142, for example as the viewing assembly 150 presses the dispenser tip 160 in a proximal direction (or prevents or inhibits the dispenser tip 160 from moving in a distal direction) and as the control assembly 130 presses the vial 142 in a distal direction (or prevents or inhibits the vial 142 from moving in a proximal direction). In this way, compression created at a first or proximal contact location 395 and a second or distal contact location 390 due to engagement between the control assembly 130 and the viewing assembly 150 operates to inhibit or prevent disengagement, or otherwise inhibit or prevent separation, between the proximal portion of the dispenser tip 160 and the distal portion of the vial 142.

In some cases, the seal between the dispenser tip 160 and vial 142 is tight and can operate as a leak-proof, water-tight seal, fluid-tight seal, and/or a liquid-tight seal. As discussed elsewhere herein, a distal portion of the vial 142 may include a tip (e.g. aa cone-shaped tip) or rim which allows the dispenser tip 160 to snap onto the vial 142. In some cases, the dispenser tip 160 may also seal with a silicone gasket. A dial or dosage knob 132 at a proximal portion of the control assembly 130 can enable a user to select a dosage or amount of preparation to dispense from the dispenser device 100. The dial or dosage knob 132 may operate by turning it clockwise (or counterclockwise) with clicks. Each click may prepare the dispenser device 100 to cause an additional 1/100th of a milliliter of medicament to be dispensed. A dispense button 136 can then depressed, which pushes a shaft 380 against the stopper 146. The stopper 146 then moves toward a distal portion of the vial 142, thereby dispensing an amount of preparation (e.g. fluid medicament) from the vial 142, into the dispenser tip 160, through the dispenser tip 160, and out of the dispenser tip 160 via an exit port of the dispenser tip (with cap 110 removed).

According to some embodiments, the viewing assembly 150 can contact the dispenser tip 160 at a contact location or zone 390. In some cases, this feature can facilitate operation of the dispenser pen 100 without the need for a needle to puncture through the cap 110. According to some embodiments, the dispenser tip 160 may be inserted into the viewing assembly 150, which also holds the vial 142 of a vial assembly, and the viewing assembly 150 can also help to serve as a locking mechanism for maintaining the vial contents within the vial and/or dispenser tip.

According to some embodiments, the dispenser device 100 can be configured so that the shaft 380 and stopper 146 may be operated only one time (e.g. as a disposable dispenser device). In some embodiments, the dispenser device 100 can be configured so that the shaft and stopper 146 may be operated multiple times (e.g. as a reusable dispenser device). In some cases, the viewing assembly or vial holder 150, with a vial 142 (e.g. a glass vial) inserted therein, can be configured so as to align a proximal portion of the vial 142 and the stopper 146 (e.g. a silicone stopper or a rubber stopper) with the shaft 380, creating a pathway for the shaft 380 to push out on the stopper 146. In some embodiments, a gearing mechanism (not shown), which can be operatively associated with the shaft 380 and the dispense button 136, can operate to prevent the shaft 380 from returning to its previous or original position (e.g. retracted) and therefore the dispenser device would not be able to re-dispense an amount of a preparation contained in the vial. In exemplary disposable embodiments, for example, the dispenser device is intended to be used only once, and the gearing mechanism and/or other components of the dispenser device 100 can be made out of less expensive materials, such as polycarbonate. A less expensive device allows for cost savings when a dispenser device need not be used more than once. In some embodiments, the stopper 146 is made of silicone. It has been surprisingly discovered that silicone is an unexpectedly advantageous material to use in fabrication of the stopper 146, because it tends not to absorb components of a Cannabis preparation. Silicone is also advantageous because it is not permeable.

When dispenser tip 160 and vial 142 are fully assembled together, the shaft 160a of the dispenser tip 160 extends into a distal opening of the vial, but not into the main chamber of the vial 142. In this way, there is maximization of the liquid or fluid seal surfaces at the junction between the dispenser tip 160 and vial, and minimization of any waste of preparation 144 (e.g. fluid or liquid) that is stored in the vial 142. Hence, the interface between the dispenser tip 160 and the vial 142 is configured so that the stopper 146 is able to travel in a distal direction to a distal portion of the vial 142 and effectively expel all or most of the preparation 144 contained within the vial 142.

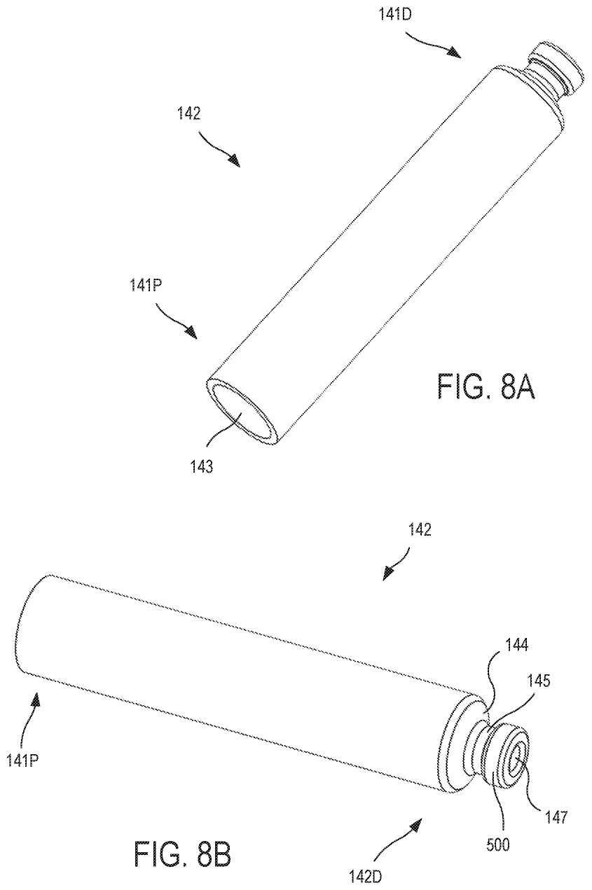

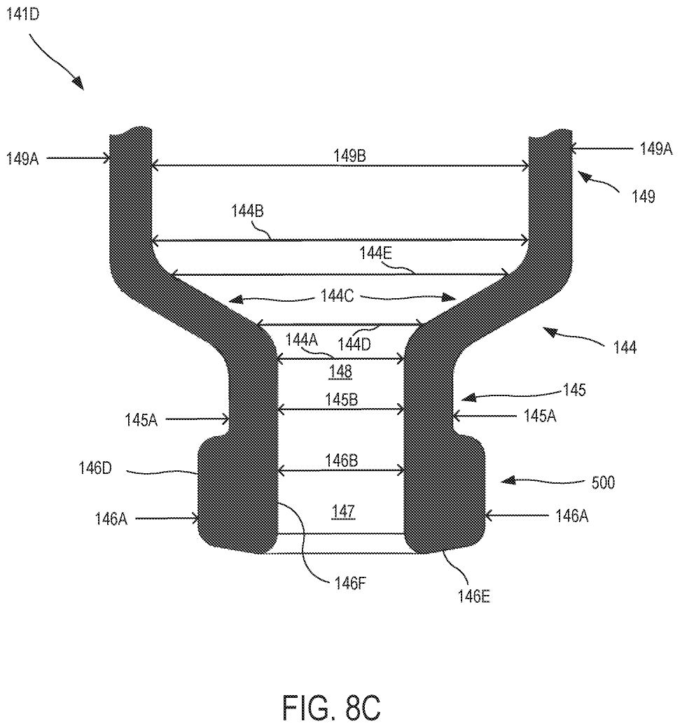

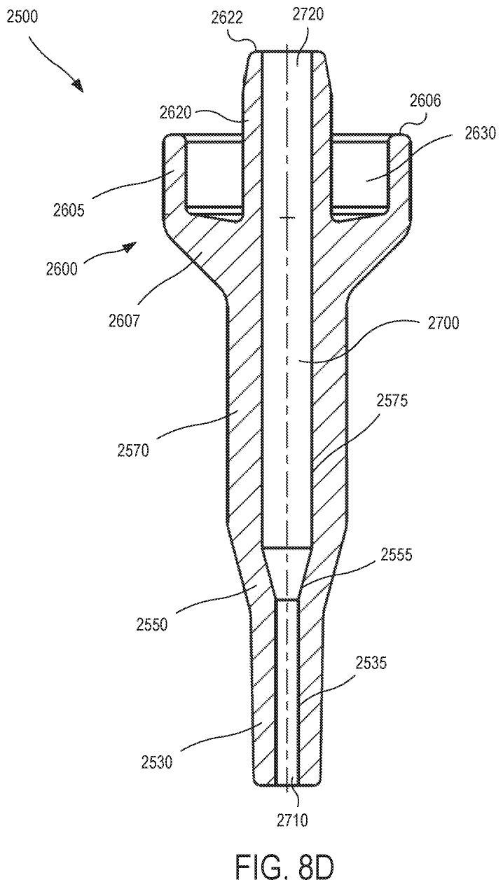

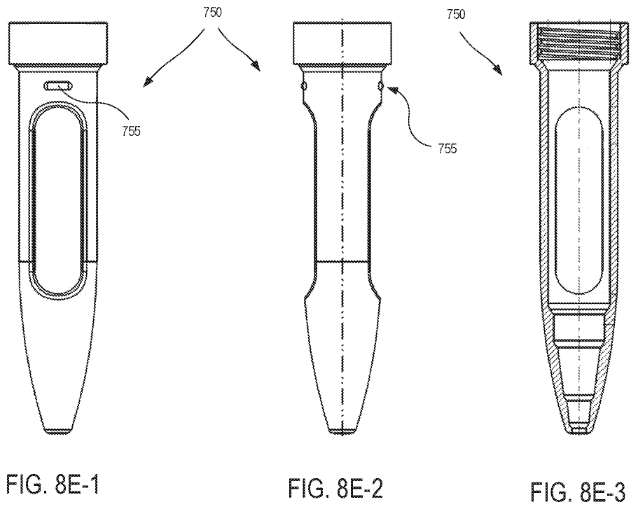

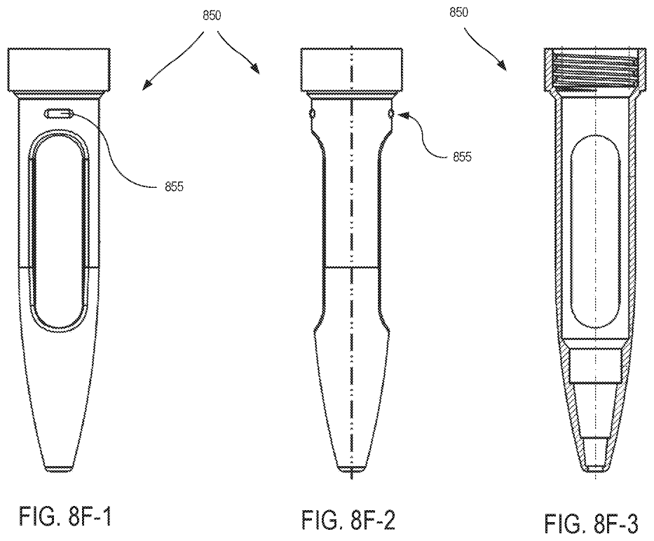

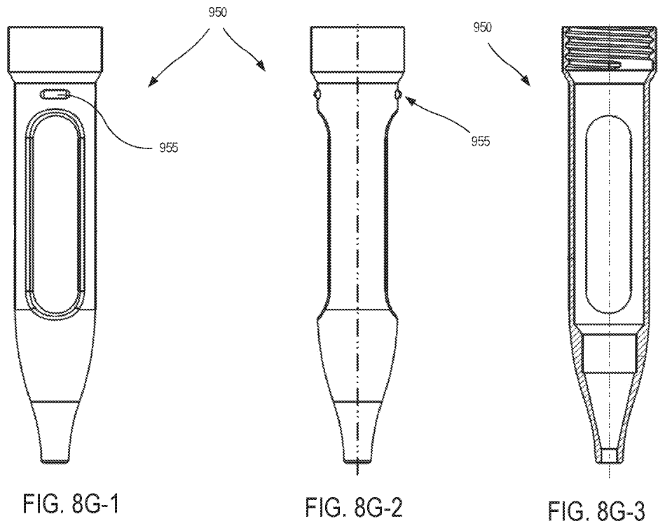

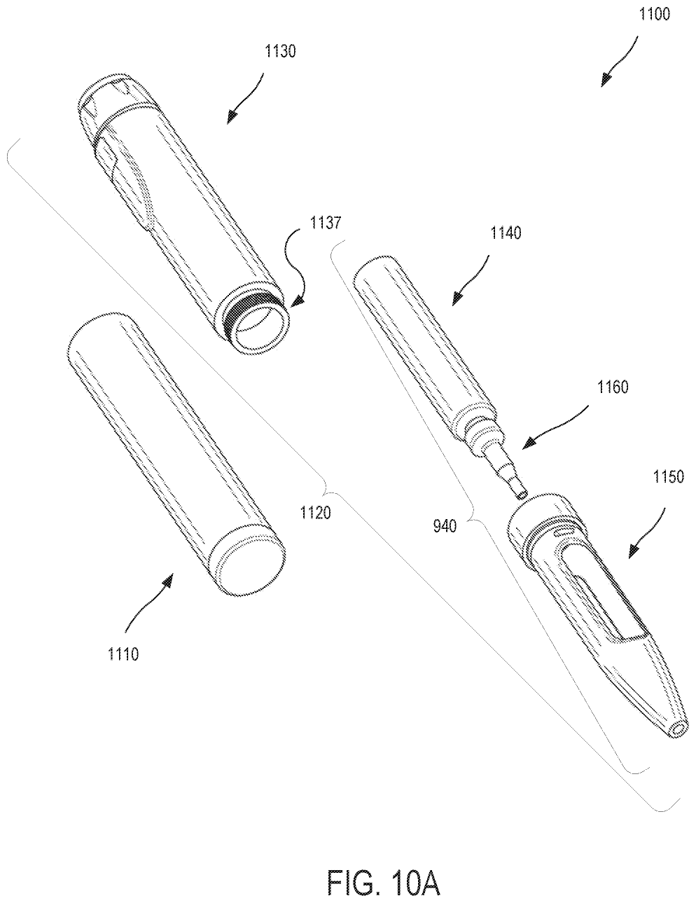

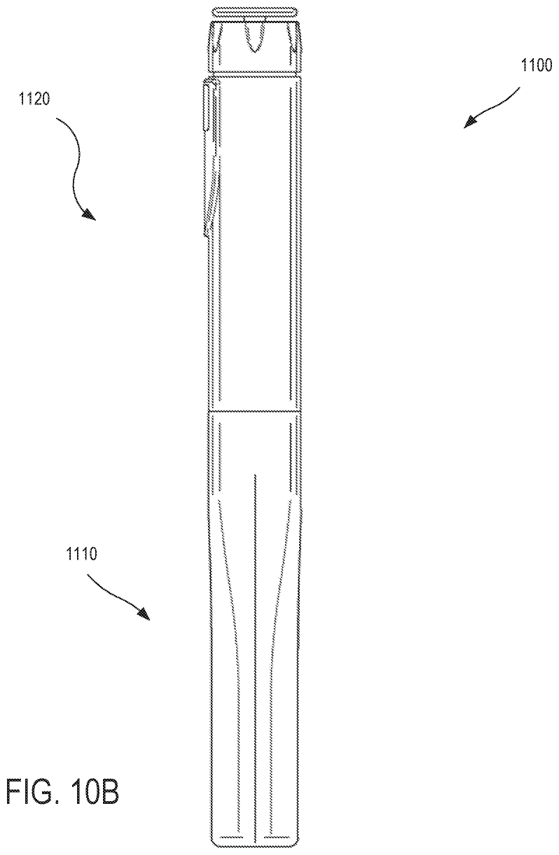

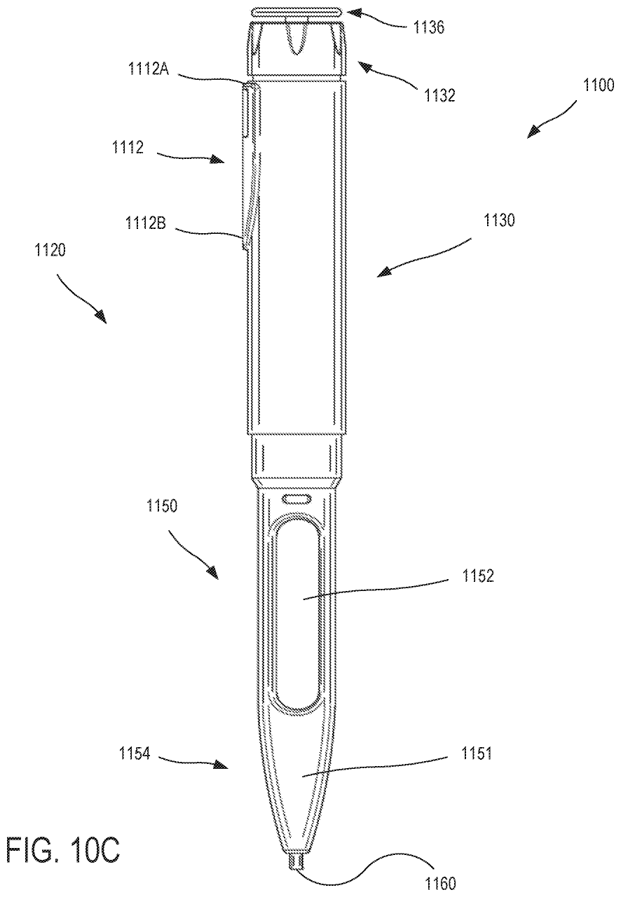

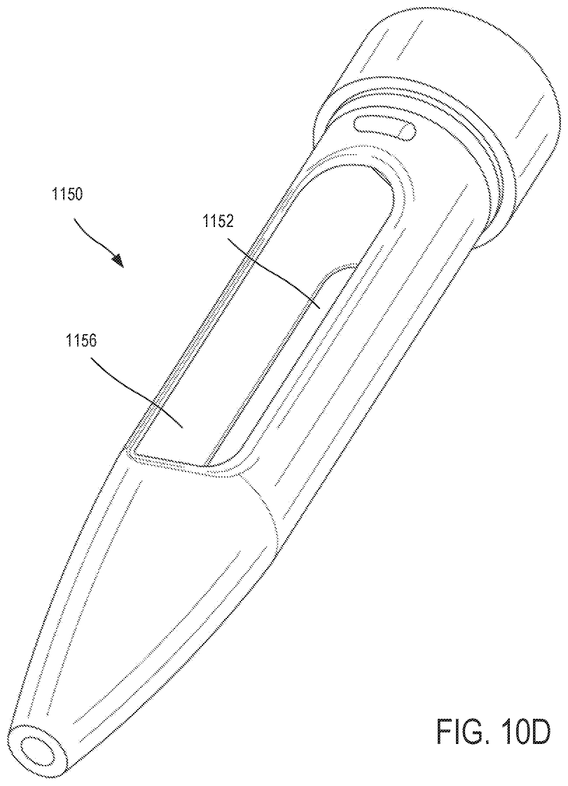

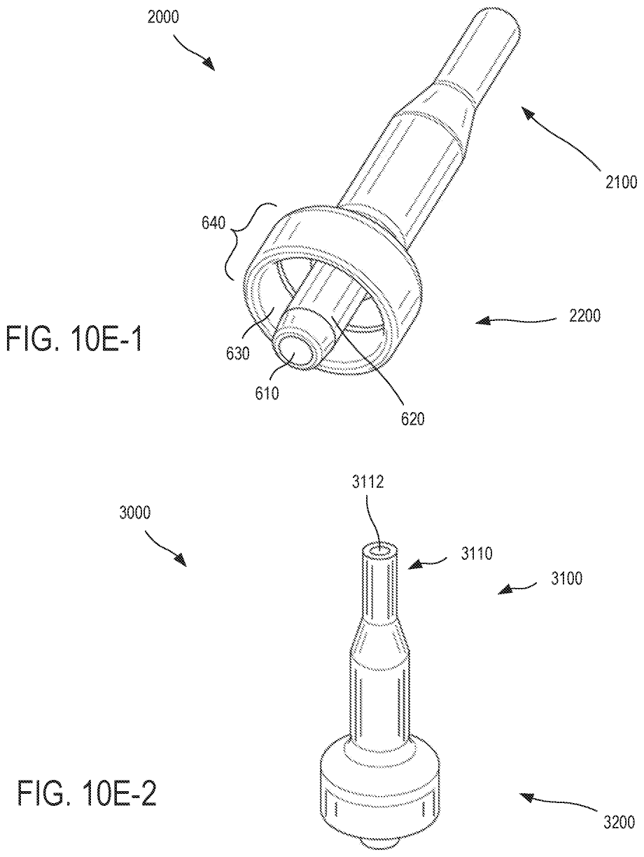

According to some embodiments, when dispenser tip 160 and vial 142 are fully assembled together, a leak-tight junction therebetween is formed. Dispenser tip 160 can be configured so that there is a surface (e.g. surface 620 depicted in FIG. 10E-1) that forms one surface of a liquid-tight seal. As discussed elsewhere here, this surface may be a tapered surface. In some cases, the outside-tapered surface (e.g. surface 620 depicted in FIG. 10E-1) can be configured to be inserted into a distal aperture of a vial (e.g. distal aperture 147 depicted in FIG. 8C). In some cases, a distal aperture of a vial has a taper that is complementary to a taper of the dispenser tip surface that contacts the inner all of the vial distal aperture.

According to some embodiments, once two such surfaces (which may be tapered surfaces) are mated and held together, they form a leak-tight junction.

FIG. 5B provides a cross-section view of a viewing assembly 150, vial 142, and dispenser tip 160 of a dispenser device, according to embodiments of the present invention. As shown here, viewing assembly 150 includes a viewing assembly coupling mechanism 159A, such as a threaded section, where the viewing assembly coupling mechanism 159A is configured to secure or couple the viewing assembly 150 with a control assembly. For example, the control assembly may have a corresponding threaded section this is configured to threadingly engage the threaded section of the viewing assembly (see, e.g. control assembly coupling mechanism 1137 depicted in FIG. 10A). FIG. 5C provides a cross-section view of a viewing assembly 150 (partial), vial 142 (partial), and dispenser tip 160 of a dispenser device, according to embodiments of the present invention. As shown here, when dispenser tip 160 and vial 142 are engaged with one another, a leak-tight junction 170 therebetween is formed. In some embodiments, dispenser tip 160 may include an inside groove 630. The groove 630 can be configured to mate to and against a molded rim 500 of the vial 142. In some cases, the inside groove 630 is part of a snap-on cap (e.g. snap-on cap 640 depicted in FIG. 10E-1) of the dispenser tip 160. In some cases, the snap-on cap can be configured to slip-over and lock onto the rim 500. In some cases, the dispenser tip 160 and the vial 142 are joined together by a snap-on mating of rim 500 of vial 142, and the snap-on cap 640 of dispenser tip 160, the snap-on connection holds pressure on the associated or apposed surfaces of the dispenser tip 160 and vial 142 at junction or interface 170, and the pressure in turn maintains the leak-tight seal of a cartridge subassembly.

According to some embodiments, there may be a slight size differential between the outer diameter of the vial rim 500 and the inner surface of the dispenser tip groove 630, such that a press fit, friction fit, or interference fit between the vial 142 and the dispenser tip 160 is created when the vial 142 and dispenser tip 160 are engaged with one another. According to some embodiments, there may be a slight size differential between the surface of the vial at interface 170 and the surface of the dispenser tip at interface 170, such that a press fit, friction fit, or interference fit between the vial 142 and the dispenser tip 160 is created when the vial 142 and dispenser tip 160 are engaged with one another. As a result, the press fit, friction fit, or interference can operate to resist separation of the engaged vial 142 and dispenser tip 160. In some cases, when the vial 142 and dispenser tip 160 are pressed together, a press fit, a friction fit, or an interference fit is formed therebetween.

It was surprisingly discovered that when the distal nozzle of the dispenser tip extends distally from the viewing assembly, as shown in FIG. 5C, there was a reduction in the amount of migration of the dispensed preparation material as it exited the exit port of the distal nozzle, as compared to configurations where the distal end of the distal nozzle was flush with the distal end of the viewing assembly. When the distal end of the distal nozzle was flush with the distal end of the viewing assembly, it was observed that a portion of the dispensed preparation material could tend to migrate from the distal nozzle to the viewing assembly, and thereby interfere with the desired dispensing action of the dispenser device. It was observed, for example, that a distal nozzle that extended 1/16 or 1/32 of an inch past the distal end of the viewing assembly results in a reduction or elimination of the migrating preparation material. Embodiments of the present invention encompass dispenser tips having any of a variety of desired sizes and/or gauges. In some cases, the size and/or gauge may be selected based on the consistency or viscosity of preparation to be dispensed. For example, with a more viscous preparation material, which may be a Cannabis dab material, a Cannabis gel material, or a Cannabis honey material, a dispenser tip with a wider gauge distal nozzle may be used (e.g. as compared to a dispenser tip for use with a less viscous Cannabis oil preparation material). Relatedly, with more viscous preparation materials, it may be advantageous to use a dispenser tip having a metal (e.g. stainless steel) distal nozzle instead of a plastic distal nozzle. Dispenser tips having metal distal nozzles can also be used with preparation materials which may benefit from heating prior to dispensing, such as Cannabis dab preparations.

What is more, as depicted in FIG. 5C, the proximal end of the dispenser tip is generally flush or aligned with the distal portion of the main body or chamber of the vial. In this way, the dispenser tip allows most or all of the preparation material to be dispensed, rather than having significant amounts of preparation material settle and/or remain in a location within the vial and circumferentially peripheral and distal to the proximal port of the dispenser tip.

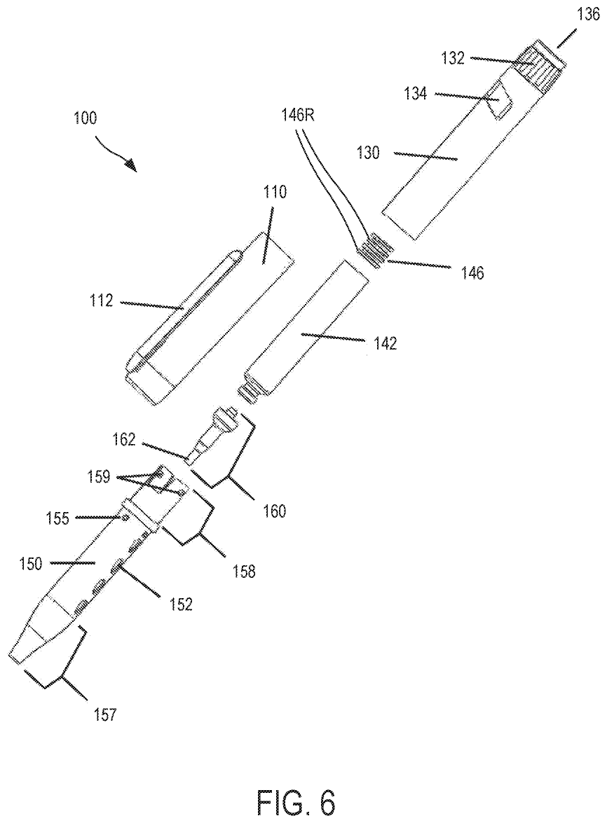

FIG. 6 provides an exploded unassembled view of a dispenser device 100, according to embodiments of the present invention. Dispenser device 100 includes a cap 110 having a clip 112. Various components of the dispenser device 100 can be made of various types of materials, including without limitation plastic, wood, or metal. For example, components can be made of stainless steel, polyvinyl chloride (PVC), acrylonitrile butadiene styrene (ABS), and the like. Dispenser device 100 also includes a control assembly or actuator assembly 130. As shown here, the control assembly 130 can include a dosage knob or setting knob 132, a dosage window or fixed-amount setting window 134, and a dispense button 136, which may be a fixed-amount dispense button. Dispenser device further includes a vial 142, which may be a fluid-holding vial, a liquid-holding vial, or a preparation-holding vial, as discussed elsewhere herein. Vial 142 may be made of glass, plastic, metal, or any other desired material. In exemplary embodiments, the vial 142 is generally tubular or cylindrical in shape. In some cases, the vial 142 may be made of a transparent or translucent material. A distal portion of the vial can be effectively sealed with a dispenser tip 160 and a proximal portion of the vial 142 can be sealed with a stopper 146. As shown here, a dispenser tip 160 can be attached with the vial 142. A distal nozzle 162 of the dispenser tip 160 provides a conduit through which an amount of a preparation can be dispensed from the dispenser device. Once the dispenser tip 160 is inserted and seated against a tapered section 157 of viewing assembly or housing 150 (e.g. of a cartridge and housing assembly), the distal nozzle 162 can operate as the protruding part of a narrowed end of the dispenser tip 160 that becomes the final dispensing feature of the dispenser device 100. The vial 142, which may be provided as liquid-holding or paste-holding vial in some embodiments, can employ a stopper 146, which may be a rubber piston or a silicon piston, for example, to both seal a proximal opening of the vial 142, and when pressed further into vial 142 in a distal direction, to create pressure and/or force that in turn causes an amount of a preparation (e.g. liquid) to be expelled from the vial 142 into dispenser tip 160, and thereafter out of dispensing tip 160.

According to some embodiments, the stopper 146 may include a plurality of annular rings 146R which operate to create a plurality of seals against the vial, and the annular rings 146R are sized so that the stopper 146 can slide within the interior chamber of the vial 142. In some embodiments, stopper 146 is made of rubber. It is understood that stopper 146 may be made of any suitable material, as a means of example but not of limitation, including plastics, rubbers, silicones, fluoropolymers; or any combination thereof. In some cases, stopper 146 can be provided as a springy metal ring. In some embodiments, stopper 146 is made of silicone. According to some embodiments, a stopper 146 made of silicone and having a plurality of rings 146R (e.g. four rings) can provide certain operational advantages. For example, some known pen devices use an aluminum and rubber seal crimped unto the neck of a vial to create a vacuum seal of the liquid contained therein. Each time an operator needs to use such a pen, the operator must screw on a new needle that pierces through the rubber seal, so as to enable the delivery of the liquid. Such pen devices typically require a stiff rubber stopper having a sufficiently wide diameter, so as to ensure that a high amount of pressure is retained inside the vial at all times. In contrast, some embodiments of the present invention include a stopper made of a softer silicone material with a smaller diameter, optionally with rings, that will give and move easier. By using a softer silicone material with a smaller diameter for the stopper, it is possible to ensure that the pressure is not excessively high which would cause leakage, and that the stopper provides a sufficiently tight seal which facilitates the dispensing of liquids quickly and accurately. In some embodiments, a stopper includes a number of rings or ribs (e.g. 4) which operate to provide a slight grip on the inner wall of the vial (e.g. a glass vial) without sticking to the vial at any point.

According to some embodiments, viewing assembly 150 can be provided as a component of a cartridge and housing assembly. As shown here, the viewing assembly 150 can include an insert section 158 configured to attach with the control assembly 130. In some cases, insert section 158 can operate to couple a cartridge and housing assembly with a control assembly. An insert section 158 may include one or more mount-locking tabs 159 that are configured to secure or couple the viewing assembly 150 with the control assembly 130. For example, the control assembly 130 may have corresponding indents or apertures that are configured to receive or otherwise engage the mount-locking tabs 159. In some cases, as describe elsewhere herein (e.g. in reference to FIG. 5A and FIG. 5B), a viewing assembly and control assembly can be coupled together with a threaded engagement arrangement. In this sense, the viewing assembly 150 can be considered to include a viewing assembly coupling mechanism (e.g. tabs 159 or threads). In some cases, a viewing assembly 150 may include one or more protruding tabs 155 that operate to engage the cap 110. In this way, the cap 110 can be snapped on to the viewing assembly 150. For example, the cap 110 may include indents or grooves that are configured to receive or otherwise engage one or more protruding tabs 155 that are disposed on the viewing assembly 150.

It has surprisingly been discovered that using silicone as a material for the stopper 146 (instead of, for example, butyl rubber) can be particularly advantageous for various reasons. It has been discovered that a silicone stopper slides easily within a glass vial, whereas a rubber stopper may exhibit stickiness to the vial. Moreover, a silicone stopper has been observed to exhibit less leaking and to retain a better seal, as compared with a butyl rubber stopper. It was also surprisingly discovered that adding more annular rings (e.g. for a total of four rings) to the stopper resulted in improved performance, by helping to reduce any stickiness between the stopper and the vial.

Moreover, it was unexpectedly discovered that by using silicon to fabricate the stopper, the stopper did not require additional processing techniques such as coating or curing, in order to obtain the desired performance. It was surprisingly discovered that silicone did not absorb constituents of the preparation contained within the vial (e.g. Cannabis constituents such as cannabinoids), whereas unwanted absorption was observed with a butyl rubber stopper.

Moreover, it was surprisingly discovered that when using a silicone stopper, Cannabis constituents such as cannabinoids did not deteriorate when they were stored within the vial, as compared with the deterioration which was observed when a preparation containing Cannabis constituents was stored in a vial assembly that included a butyl rubber stopper. When comparative testing between a silicone stopper and a butyl rubber stopper was performed, it was observed that the active cannabinoid content within a vial assembly having a silicone stopper remained more consistent or at higher levels, as compared to the active cannabinoid content within a vial assembly having a butyl rubber stopper. In some cases, the testing was performed over the course of a week.

In some embodiments, a viewing assembly 150 can include one or more material-level sight windows 152. For example, a sight window or aperture 152 can have an oval shape. During operation of the dispenser device 100, as a stopper 146 travels through the vial 142 (e.g. in a distal direction), the user can view the stopper 146 through the sight window 152 and the vial 142, and the position of the stopper 146 within the vial 142 can provide a visual indication to the user of the approximate amount of material that remains in the vial 142. In some embodiments, the viewing assembly 150 depicted here may be referred to as a disposable holder for a vial 142. In some cases, dispenser device 100 can be provided as a disposable device.

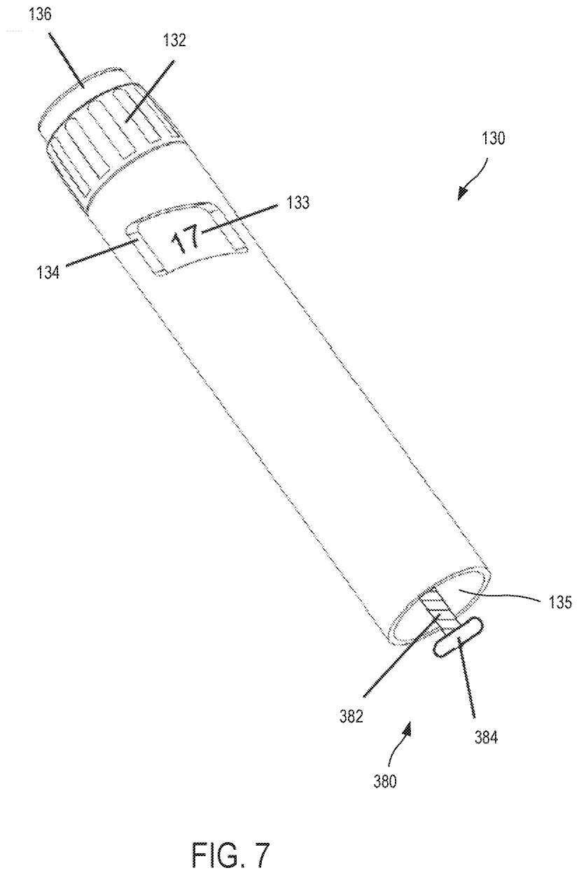

FIG. 7 illustrates aspects of a control assembly or actuator assembly 130, according to embodiments of the present invention. As shown here, control assembly 130 includes a dosage knob or fixed-amount setting knob 132, a dosage window or fixed-amount setting window 134, and a dispense button 136, which may be a fixed-amount dispense button. As shown here, the control assembly 130 can provide the user with an indication of a set or fixed amount which is dispensed by a dispenser device upon actuation of the dispense button 136. For example, in the dosage window, a printed text or symbol 133 can be seen by the user. In the embodiment depicted here, the symbol 133 indicates that upon actuation of the dispense button 136, a fixed amount of 17 microliters will be dispensed by the dispenser device. A user can select a desired amount to be dispensed, by rotating the dosage knob or setting knob 132, which in turn will change the value of the symbol 133 shown in the dosage window 134.

In some embodiments, the configuration, location, and action the dosage knob 132, dosage window 134, and/or dispense button 136 may be dependent on which type of control assembly 130 a user may wish to use. For example, if a control assembly 130 is provided as a radio or infra-red linked electronically-controlled embodiment, then the control assembly may not include a dosage knob 132, a dosage window 134, and/or a dispense button 136. In some embodiments, a control assembly 130 may include a shaft 380. In some cases, and as explained elsewhere herein (e.g. with reference to FIG. 5A), a shaft 380 may provide a mechanism by which the control assembly 130 can be used to move a stopper within a vial of a dispenser device. In some cases, a shaft 380 may include a piston rod 382 and a piston pad 384. In some cases, the piston rod 382 may extend out of a distal aperture 135 of the control assembly 130, or in a distal direction relative to the dosage knob and/or dosage window 134, when the dispenser device is operated by the user by pressing on the dispense button 136. The piston rod 382 can develop sufficient force, and provide sufficient reach, to move a stopper that is disposed within a vial. In some embodiments, piston pad 384 is manufactured from a firm material, such as a firm rubber or plastic material.

FIGS. 8A, 8B, and 8C illustrate aspects of a vial 142, according to embodiments of the present invention. As shown in FIG. 8A, a vial 142 can include a proximal portion 141P and a distal portion 141D. The proximal portion 141P includes a proximal opening or aperture 143 and is configured to slidingly receive a stopper (not shown), as described elsewhere herein (e.g. stopper 146 shown in FIG. 5A). The stopper can operate as a proximal seal for the vial 142, and prevent material from exiting the proximal aperture 143. The distal portion 141D includes a shoulder 144, neck 145, and rim 500. As discussed elsewhere herein, the rim 500 includes a distal aperture 147, and the distal aperture 147 is configured to slidingly receive a portion of a dispenser tip (not shown). The rim 500 can provide a leak-free seal with the dispenser tip. According to some embodiments, vial assembly 140 is configured to contain or hold 3 fluid ounces (approx. 88.72 mL) of a liquid or other material. In some cases, vial 142 can be configured to contain a volume of material that is within a range from about 1 ounce (approx. 29.57 mL) to about 5 ounces (approx. 147.87 mL). Embodiments of the present invention encompass other volume configurations for the vial assembly as well. In some cases, vial 142 is molded out of glass. In some cases, vial 142 is made of a plastic or a polymer, such as polycarbonate. In some cases, vial 142 can include metal.

FIG. 8C provides a partial cross-section view of a distal portion 141D of a vial assembly. As depicted here, the distal portion 141D includes a body 149, a shoulder 144, a neck 145, and a rim 500. The rim 500 includes a distal aperture 147, and the distal aperture 147 is configured to slidingly receive a portion of a dispenser tip (not shown). Rim 500 is generally tubular in shape, and has an outer diameter 146A and an inner diameter 146B. Likewise, neck 145 is generally tubular in shape, and has an outer diameter 145A and an inner diameter 145B. Similarly, body 149 is generally tubular in shape, and has an outer diameter 149A and an inner diameter 149B. In the embodiment shown here, rim inner diameter 146B is equivalent to neck inner diameter 145B, such that distal aperture 147 aligned with a neck conduit 148 defined by the neck 145. The shoulder 144 is tapered, and defines a minimum inner diameter 144A and a maximum inner diameter 144B. As shown here, the minimum inner diameter 144A is equivalent to neck inner diameter 145B, and the maximum inner diameter 144B is equivalent to the inner diameter 149B of the body 149 of the vial assembly. The rim outer diameter 146A has a value that is greater than the neck outer diameter 145A, and the body outer diameter 149A is greater than the rim outer diameter 146A. Shoulder 144 also defines linear interior transition zone 144C having a minimum inner diameter 144D and a maximum inner diameter 144E.

As depicted in FIG. 8C, the vial rim 500 can have an outer surface 146D, a distal surface 146E, and an inner surface 146F. As discussed elsewhere herein, one or more of these surfaces may contact corresponding surfaces of a dispenser tip, when the vial is engaged with a dispenser tip.

FIG. 8D is a cross-section view of a dispenser tip 2500, according to embodiments of the present invention. As shown here, dispenser tip 2500 includes a distal nozzle 2530, a transition 2550, a distal shaft 2570, a flange 2600 having a proximal portion 2605 and a distal portion 2607, a proximal shaft 2620, a proximal groove 2630, and a central longitudinal conduit 2700 extending between a distal exit port 2710 and proximal port or vial port opening 2720. The proximal portion 2605 of the flange 2600 has a proximal edge 2606 (e.g. a circumferential edge). The proximal shaft 2620 has a proximal edge 2622 (e.g. a circumferential edge). The proximal edge 2622 of the proximal shaft 2620 is disposed proximal to the proximal edge 2606 of the proximal portion 2605 of the flange 2600. The central longitudinal conduit 2700 can be defined by a distal conduit inner surface 2535, a central conduit inner surface 2555, and a proximal conduit inner surface 2575. As discussed elsewhere herein, the proximal groove 2630 of the dispenser tip 2500 can be configured to receive a distal rim of a vial.

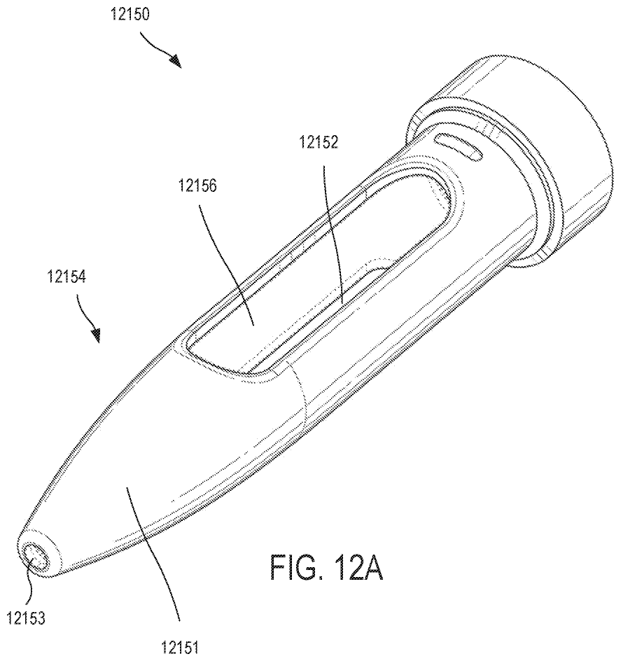

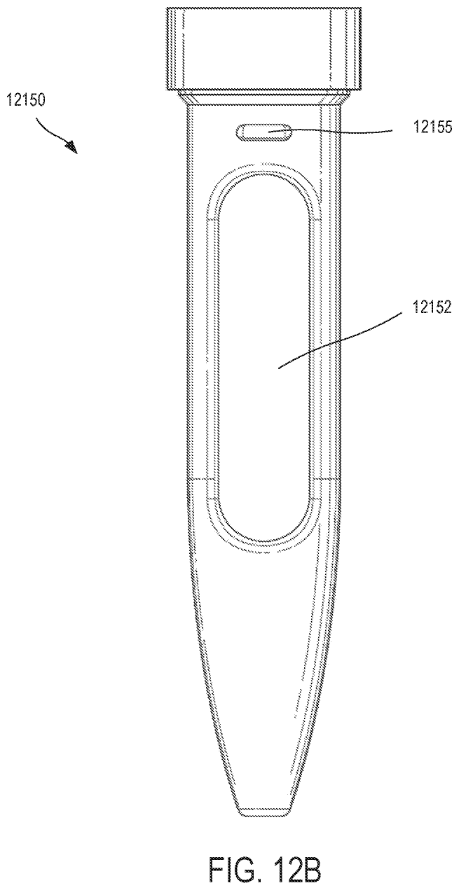

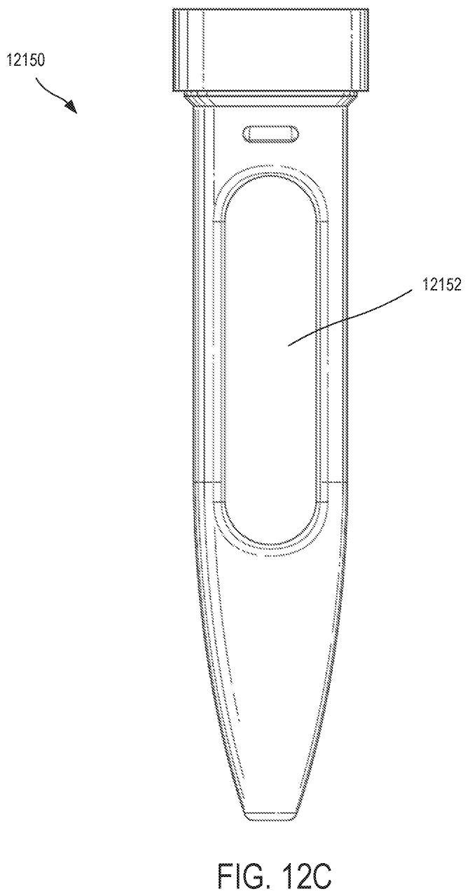

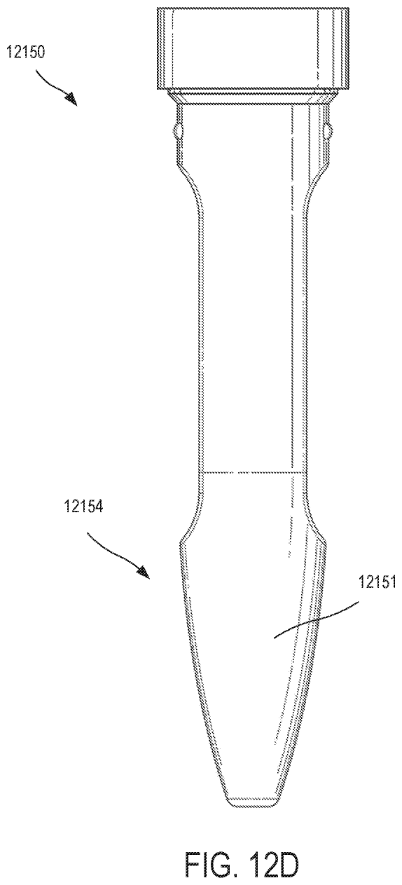

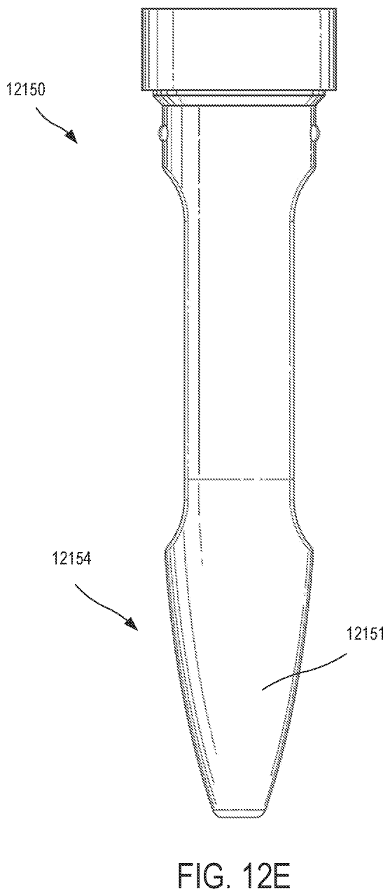

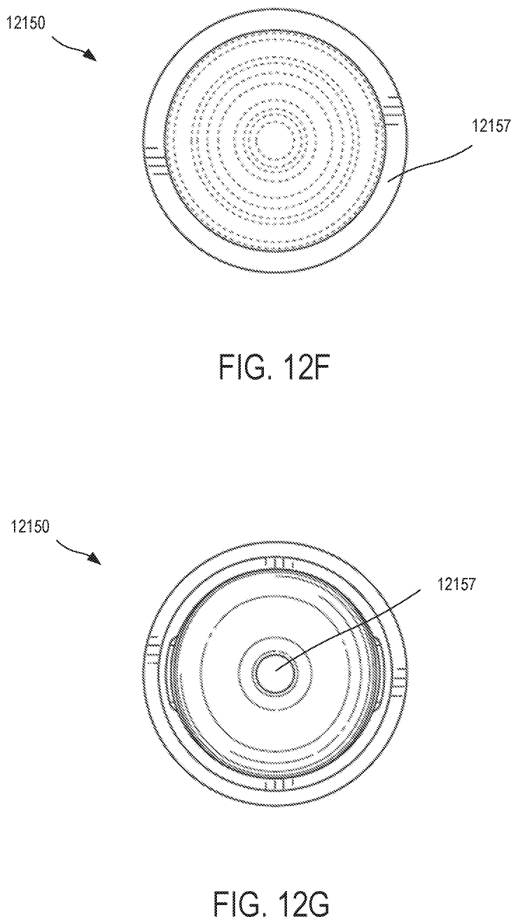

FIGS. 8E-1, 8E-2, and 8E-3 depict a viewing assembly 750, according to embodiments of the present invention. FIG. 8E-1 provides a front and/or back view, FIG. 8E-2 provides a side view, and FIG. 8E-3 provides a cross-section view. In some embodiments, the viewing assembly 750 depicted here may be referred to as a reusable holder for a vial. In some cases, viewing assembly 750 can be provided as a part of, or as a part for, a reusable dispenser device. In some cases, a viewing assembly 750 may include one or more protruding tabs 755 that operate to engage a cap. In this way, a cap can be snapped on to the viewing assembly 750. For example, the cap may include indents or grooves that are configured to receive or otherwise engage one or more protruding tabs 755 that are disposed on the viewing assembly 750. In some embodiments, one or more features of viewing assembly 750 may be included in the viewing assembly depicted in FIGS. 12A-12G. Conversely, in some embodiments, one or more features of the viewing assembly depicted in FIGS. 12A-12G may be included in viewing assembly 750.

FIGS. 8F-1, 8F-2, and 8F-3 depict a viewing assembly 850, according to embodiments of the present invention. FIG. 8F-1 provides a front and/or back view, FIG. 8F-2 provides a side view, and FIG. 8F-3 provides a cross-section view. In some embodiments, the viewing assembly 850 depicted here may be referred to as a reusable holder for a vial. In some cases, viewing assembly 850 can be provided as a part of, or as a part for, a reusable dispenser device. In some cases, a viewing assembly 850 may include one or more protruding tabs 855 that operate to engage a cap. In this way, a cap can be snapped on to the viewing assembly 850. For example, the cap may include indents or grooves that are configured to receive or otherwise engage one or more protruding tabs 855 that are disposed on the viewing assembly 850. In some embodiments, one or more features of viewing assembly 850 may be included in the viewing assembly depicted in FIGS. 12A-12G. Conversely, in some embodiments, one or more features of the viewing assembly depicted in FIGS. 12A-12G may be included in viewing assembly 850.

FIGS. 8G-1, 8G-2, and 8G-3 depict a viewing assembly 950, according to embodiments of the present invention. FIG. 8G-1 provides a front and/or back view, FIG. 8G-2 provides a side view, and FIG. 8G-3 provides a cross-section view. In some embodiments, the viewing assembly 950 depicted here may be referred to as a reusable holder for a vial. In some cases, viewing assembly 950 can be provided as a part of, or as a part for, a reusable dispenser device. In some cases, a viewing assembly 950 may include one or more protruding tabs 955 that operate to engage a cap. In this way, a cap can be snapped on to the viewing assembly 950. For example, the cap may include indents or grooves that are configured to receive or otherwise engage one or more protruding tabs 955 that are disposed on the viewing assembly 950. In some embodiments, one or more features of viewing assembly 950 may be included in the viewing assembly depicted in FIGS. 12A-12G. Conversely, in some embodiments, one or more features of the viewing assembly depicted in FIGS. 12A-12G may be included in viewing assembly 950.

The viewing assemblies depicted in FIGS. 8E-1 to 8G-3 have a single elongate window on each side of the assembly, and can be particularly suited for use in a reusable dispenser device embodiment (e.g. where the viewing assembly is coupled with the control assembly via a threaded coupling connection). In contrast, a viewing assembly as depicted in FIG. 1 has multiple apertures or windows on each side of the assembly ,and can be particularly suited for use in a disposable dispenser device embodiment (e.g. where the viewing assembly is coupled with the control assembly via a snap-tab coupling connection).

According to some embodiments, a viewing assembly can be fabricated from a polycarbonate material. Such embodiments may be advantageous over embodiments using ethylene bis-stearamide (EBS) viewing assemblies, as EBS may tend to absorb oil, crack, or otherwise become defective during use, particularly during use with Cannabis preparations.

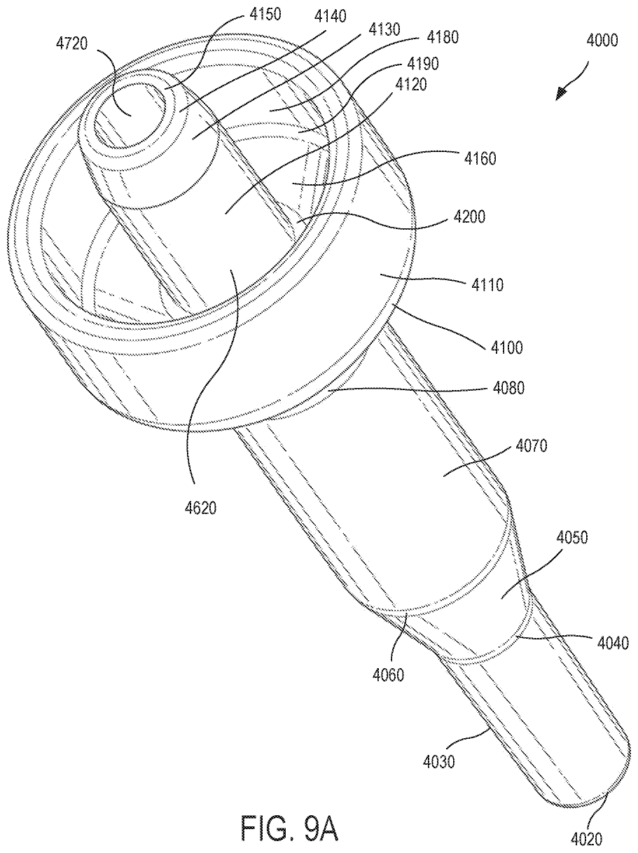

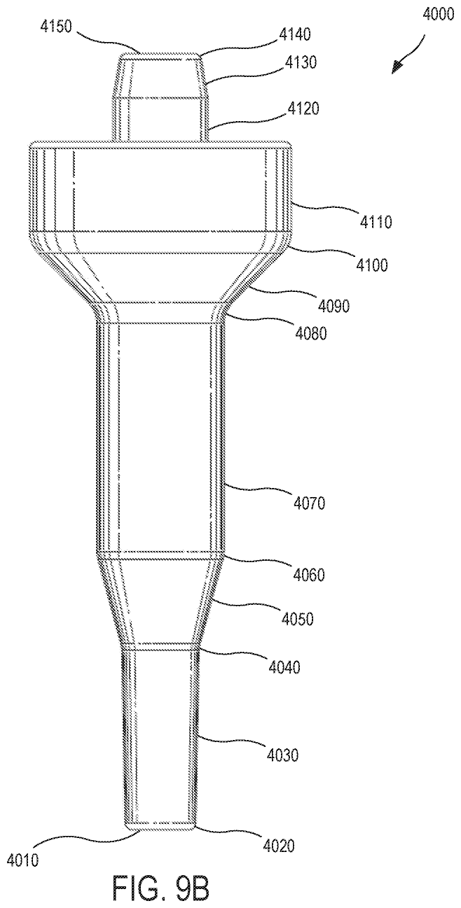

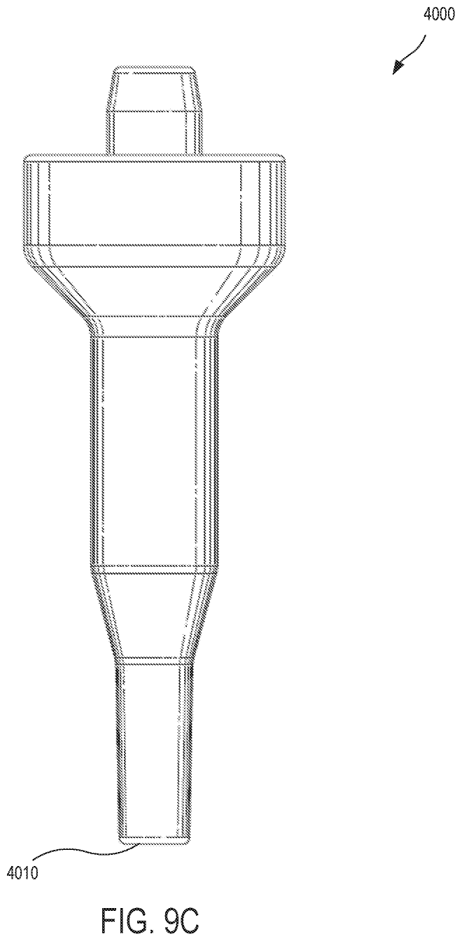

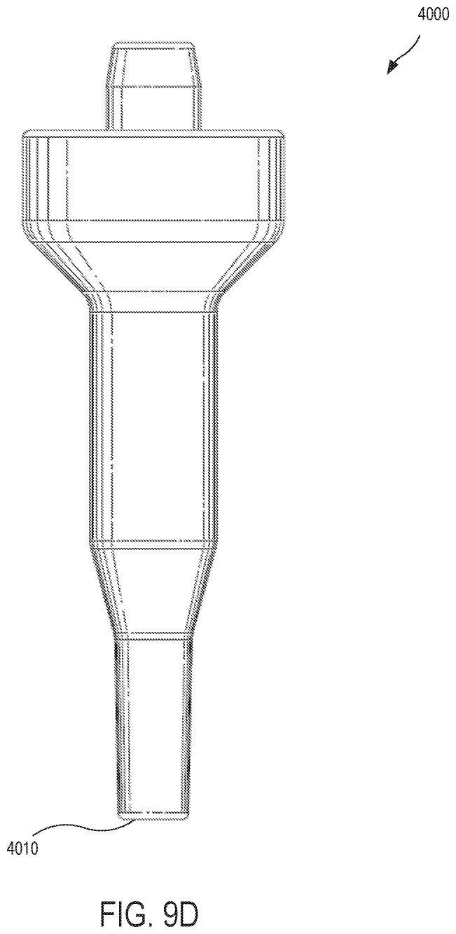

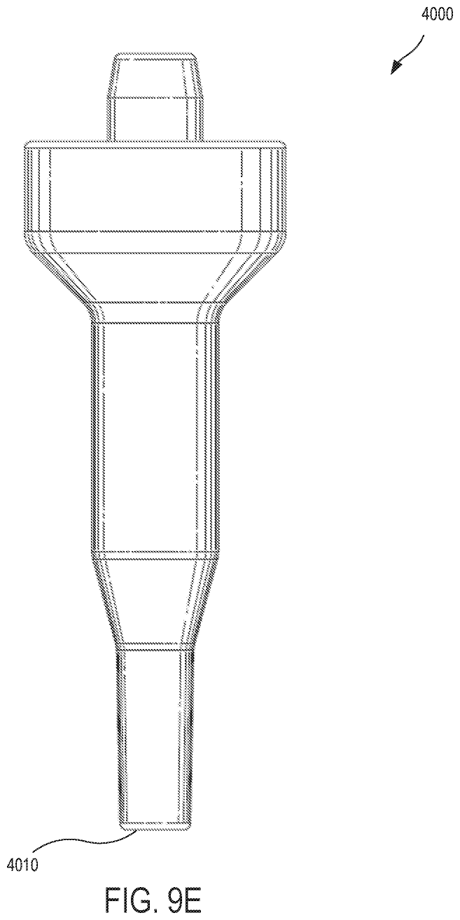

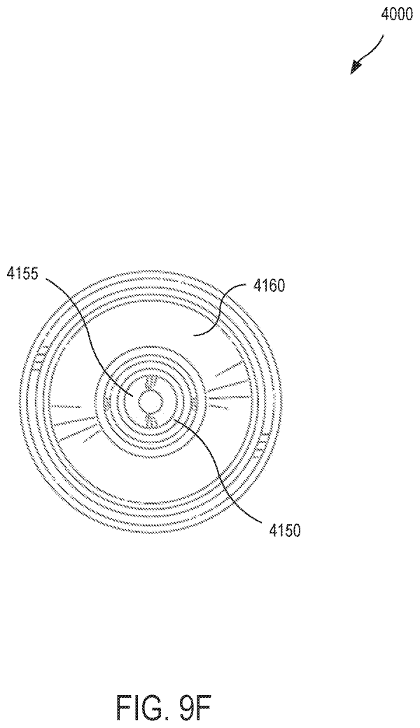

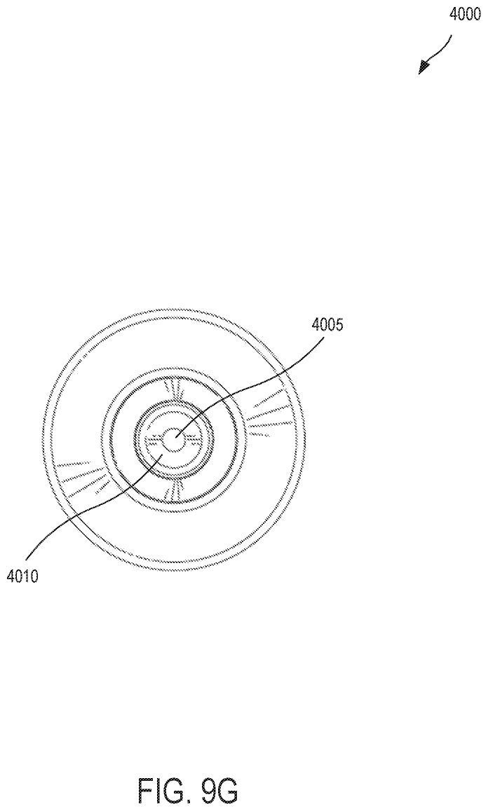

FIGS. 9A-9G illustrate aspects of a dispenser tip 4000, according to embodiments of the present invention.

FIG. 9A is a top perspective view of a dispenser tip showing a new design. As shown here, dispenser tip 4000 can include a distal chamfer surface 4020, a distal nozzle surface 4030, a distal bezel surface 4040, a transition surface 4050, a proximal bezel surface 4060, a distal shaft surface 4070, a distal skirt surface 4080, a proximal skirt surface 4100, a proximal body surface 4110, a proximal shaft surface 4120, a proximal nozzle surface 4130, a proximal chamfer surface 4140, and a proximal flat surface 4150. Dispenser tip 4000 can also include a flange distal portion inner surface 4160, a flange proximal portion inner surface 4180, an inner bevel 4190 between the flange distal portion inner surface 4160 and the flange proximal portion inner surface 4180, and an inner bevel 4200 between the flange distal portion inner surface 4160 and the proximal shaft surface 4120. According to some embodiments, when a dispenser tip is engaged with a vial, the proximal shaft surface 4120 can contact an inner surface of the vial rim (e.g. inner surface 146F depicted in FIG. 8C), the flange distal portion inner surface 4160 can contact a distal surface of the vial rim (e.g. distal surface 146E depicted in FIG. 8C), and the flange proximal portion inner surface 4180 can contact an outer surface of the vial rim (e.g. outer surface 146D depicted in FIG. 8C). As shown in FIG. 9A, a proximal portion of the dispenser tip 4000 can include a proximal shaft 4620 having a vial port opening 4720.

FIG. 9B is a front elevation view of a dispenser tip showing a new design. As shown here, dispenser tip 4000 can include a distal flat surface 4010, a distal chamfer surface 4020, a distal nozzle surface 4030, a distal bezel surface 4040, a transition surface 4050, a proximal bezel surface 4060, a distal shaft surface 4070, a distal skirt surface 4080, a waist surface 4090, a proximal skirt surface 4100, a proximal body surface 4110, a proximal shaft surface 4120, a proximal nozzle surface 4130, a proximal chamfer surface 4140, and a proximal flat surface 4150.

FIG. 9C is a rear elevation view of a dispenser tip showing a new design. As shown here, dispenser tip 4000 can include a distal flat surface 4010, as well as other elements as depicted in FIGS.9A and/or 9B.

FIG. 9D is a right side elevation view of a dispenser tip showing a new design. As shown here, dispenser tip 4000 can include a distal flat surface 4010, as well as other elements as depicted in FIGS.9A and/or 9B.

FIG. 9E is a left side elevation view of a dispenser tip showing a new design. As shown here, dispenser tip 4000 can include a distal flat surface 4010, as well as other elements as depicted in FIGS.9A and/or 9B.

FIG. 9F is a top plan view of a dispenser tip showing a new design. As shown here, dispenser tip 4000 can include a proximal flat surface 4150, a flange distal portion inner surface 4160, and a central conduit inner surface 4155, as well as other elements as depicted in FIGS. 9A and/or 9B.

FIG. 9G is a bottom plan view of a dispenser tip showing a new design. As shown here, dispenser tip 4000 can include a distal flat surface 4010 and a distal exit port 4005, as well as other elements as depicted in FIGS. 9A and/or 9B.

According to some embodiments, the dispenser tip depicted in FIGS. 9A-9G is used with or is a component of a dispenser device. According to some embodiments, the dispenser tip depicted in FIGS. 9A-9G engages with a vial assembly of a dispenser device. According to some embodiments, the dispenser tip depicted in FIGS. 9A-9G engages with a viewing assembly of a dispenser device. According to some embodiments, the instant application discloses an ornamental design for a dispenser tip as shown in FIGS. 9A-9G. According to some embodiments, the instant application enables a claim for an ornamental design for a dispenser tip as shown in FIGS. 9A-9G. According to some embodiments, the instant application discloses an ornamental design for a dispenser tip for a dispenser device as shown in FIGS. 9A-9G. According to some embodiments, the instant application enables a claim for an ornamental design for a dispenser tip for a dispenser device as shown in FIGS. 9A-9G.

In some embodiments, FIGS. 9A-9G depict aspects of a design (e.g. an ornamental design) for a dispenser tip. Embodiments of the present invention encompass one or more ornamental designs or ornamental characteristics that are embodied in the dispenser tip depicted in FIGS. 9A-9G, and which may relate to the configuration or shape of the dispenser tip depicted in FIGS. 9A-9G. In some cases, the ornamental designs or characteristics may be embodied in the entire dispenser tip shown in FIGS. 9A-9G. In some cases, the ornamental designs or characteristics may be embodied in only a portion of or in certain features of the dispenser tip shown in FIGS. 9A-9G. The scope of the design is not defined or limited by the solid line structure depicted in FIGS. 9A-9G. Where the ornamental designs or characteristics are embodied in only a portion of or in certain features of the dispenser tip, it is understood that one or more portions of or certain features of the solid line structure depicted in FIGS. 9A-9G can be converted to or replaced with broken or dashed lines, whereby such broken or dashed lines may form no part of a claimed design, whereby such broken or dashed lines may represent a portion of the design that is unclaimed, and/or whereby such broken or dashed lines may include a portion of the dispenser tip in which the design is embodied, without resulting in a change in configuration of the design embodied in FIGS. 9A-9G. For example, but without limitation, it is understood that the distal bezel surface, transition surface, and/or proximal bezel surface portion(s) of the design embodied in the dispenser tip depicted in FIGS. 9A-9G may be claimed separately from the remainder of the design. Embodiments of the present invention encompass one or more design claims directed to one or more subsets of the features or elements illustrated in FIGS. 9A-9G. Any broken or dashed lines present in FIGS. 9A-9G may be disclaimed portions of the dispenser tip as forming no part of a claimed design or a design to be patented. It is understood that one or more portions of or certain features of any broken or dashed lines depicted in FIGS. 9A-9G can be converted to or replaced with solid line structure, without resulting in a change in configuration of the design embodied in FIGS. 9A-9G.

FIGS. 10A-10E-2 illustrate aspects of a single chamber mechanical dispenser, according to embodiments of the present invention.

FIG. 10A is a perspective view of the front, left, and top view of a single chamber mechanical dispenser disassembled how user might take it apart to change vials, according to embodiments of the present invention. Shown are the actuator body, vial, vial holder, and cap, according to embodiments of the present invention. As illustrated in FIG. 10A, a dispenser device 1100 (e.g. single chamber mechanical dispenser) may include a cap 1110 and a main body 1120. The main body includes a control assembly 1130 (e.g. actuator body), a vial assembly 1140 (e.g. vial), a viewing assembly 1150 (e.g. vial holder), and a dispenser tip 1160.

In this illustration, aspects of the dispenser device 1100 are shown in an unassembled state. In some embodiments, the term “cartridge and housing assembly” 940 can refer to the combination of the viewing assembly 1150 and a cartridge subassembly (e.g. vial assembly 1140 and dispenser tip 1160). In some embodiments, the viewing assembly 1150 depicted here may be referred to as a reusable holder for a vial. In some cases, dispenser device 1100 can be provided as a reusable device. As shown here, a control assembly 1130 can include a control assembly coupling mechanism 1137, such as a threaded section, where the control assembly coupling mechanism 1137 is configured to secure or couple the control assembly 1130 with the viewing assembly 1150 (e.g. via a viewing assembly coupling mechanism, such as viewing assembly coupling mechanism 159A depicted in FIG. 5B). For example, the viewing assembly may have a corresponding threaded section this is configured to threadingly engage the threaded section of the control assembly.

According to some embodiments, dispenser device 1100 is manufactured, sold, or otherwise provided to be a single-use dispenser device. In some cases, a junction between a control assembly or actuator assembly 1130 and a cartridge and housing assembly 940 can be made permanent using gluing or fusing techniques, including without limitation techniques such as ultrasonic welding, adhesives, fixtures, and the like. In some cases, the control assembly 1130 may be non-resettable.

FIG. 10B is a left side view of the single chamber mechanical dispenser shown in FIG. 10A with the cap affixed thereto, according to embodiments of the present invention. As illustrated in FIG. 10B, the dispenser device 1100 includes a cap 1110 and a main body 1120.

FIG. 10C is a left side view of the single chamber mechanical dispenser shown in FIG. 10A with the cap removed, according to embodiments of the present invention. As illustrated in FIG. 10C, the dispenser device 1100 includes a main body 1120 and a cap (not shown).

A control assembly 1130 of the dispenser device 1100 may include or be coupled with a pocket clip 1112 that allows a user to clip the dispenser system 1100 to a pocket or a strap. Clip 1112 can include an elongate arm having one end 1112A coupled to the control assembly 1130 and an opposite free end 1112B that cantilevers away from the control assembly 1130 to create a space for receiving a material thereby clipping the control assembly 1130 to the material. By virtue of this configuration, the dispenser device 1100 can be stored in a pocket of a user's garment (e.g. shirt, jacket, pants) in a “tip down” orientation, whereby the exit port of the dispenser tip 160 is facing toward the ground.

According to some embodiments, the term “actuator assembly” may refer to the control assembly 1130. In some cases, the actuator assembly can refer to a subassembly of the complete pen assemblage 1100 that incorporates and secures the mechanism that provides the motive force for the stopper in the vial assembly. In practice, such an actuator mechanism may be fully mechanical in nature, or may be a hybrid of mechanical and electrical means. In some cases, the actuator mechanism or control assembly may include features of one or more of U.S. Pat. No. 5,456,672 (Diederich), U.S. Pat. No. 5,879,336 (Brinon), U.S. Pat. No. 6,957,752 (Py), 7,018,364 (Giambattista), U.S. Pat. No. 7,828,231 (Harms), U.S. Pat. No. 8,608,708 (Cowe), and U.S. Pat. No. 9,108,003 (Forstreuter), and U.S. Patent Publication No. 2017/0100738 (Kendziorek), the contents of each of which are incorporated herein by reference, so as to enable for the delivery of a controlled, fixed, and/or metered amount of a preparation.

The control assembly 1130 can include a fixed-amount setting selection mechanism such as a dosage knob 1132 that can be adjusted to select a fixed-amount (amount to be dispensed) of preparation. In some cases, the fixed-amount setting selection mechanism may be something other than a knob. In some cases, for example in the instance of an electronic version of a dispenser device, a radio-link or infra-red link to a smartphone or other electronic device could be used (instead of a dosage knob) to set the fixed-amount. In some cases, a control assembly may be of an electronic design in part or in full, and a dispense button or fixed-amount activation button 1136 may omitted in favor of using a radio-link or infra-red link to a smartphone or other electronic device for activation and delivery of the fixed-amount. In some cases, a dispenser device can be configured to be controlled by or in communication with a software application or other programming mechanism, whereby data can be collected for verifiable analytics.

In use, the operator can press the dispense button 1136, which may also be referred to as a fixed-amount dispense button, so as to cause the dispenser device 1100 to expel a fixed-amount in the amount as set by the fixed-amount setting. While certain embodiments disclosed herein show such fixed-amount dispensing mechanisms located at the top or proximal portion of a control assembly, such fixed-amount activation mechanisms may be located elsewhere, such as at a central portion of a control assembly or at a distal portion of a control assembly.

The main body 1120 may include a viewing assembly 1150 having a viewing window or material-level sight window 1152. A viewing window 1152 can be used by an operator to perform a visual check of the remaining amount of preparation or liquid disposed in a vial (not shown), which may be aided by a view of the position of the vial stopper (not shown), which may be colored so to assist the user visually. In some embodiments, a viewing or sight window 1152 can be a single cut-out of the viewing assembly 1150. As discussed elsewhere herein, the viewing assembly 1150 can house at least a portion of a cartridge subassembly.

As noted above, the term “cartridge and housing assembly” can refer to the combination of the viewing assembly 1150 and a cartridge subassembly. In some cases, a cartridge and housing assembly includes a vial (which may be filled with a preparation such as a liquid to be dispensed), the dispenser tip for dispersal of the preparation or liquid, a stopper or piston part that is inserted at the proximal portion or base of the vial which in turn is pressed to cause the release of the preparation or liquid, and any functional and/or decorative plastic, wood, ceramic, or metallic housing.

As shown in FIG. 10C, a distal portion 1154 of the viewing assembly 1150 can include a tapered section 1151 can operate to secure and limit the travel of a dispenser tip when the dispenser tip is received by or engaged with the viewing assembly 1150. In some embodiments, the tapered section 1151 narrows towards the dispensing or distal end of the dispenser device 1100. In some cases, the tapered section 1151 of the viewing assembly 1150 is formed and used to secure and limit the travel of the dispenser tip of the cartridge subassembly that is internal to the cartridge and housing assembly, and the vial is visible through the vial sight window 1152. The liquid-exit port of dispenser tip 1160 can protrude through a narrowing of viewing assembly 1150, and is a visible component of the dispenser tip. When the pen is being stored, the dispenser tip can be protected from physical damage by a cap or cap assembly (not shown).

According to some embodiments, the term “cap assembly” can refer to a subassembly that fits over a portion, or even a majority (e.g. greater than 50%) of a cartridge and housing assembly when the dispenser device is stored or otherwise not in use. In some cases, a cap subassembly can operate to protect the tip or distal portion of the dispenser device. In some cases, one or more aspects of a cap assembly can operate to provide a decorative function. In some cases, one or more aspects of a cap assembly can operate to provide a securement function. In some cases, a cap assembly can include a cap such as cap 110 depicted in FIG. 1.

FIG. 10D is a perspective view of the front, left, and top view of the vial holder of the single chamber mechanical dispenser shown in FIG. 10A, according to embodiments of the present invention. As illustrated in FIG. 10E, a viewing assembly 1150 (e.g. vial holder) may include an aperture or window 1152. Viewing assembly 1150 includes an interior chamber 1156 that is configured to receive a vial and/or a dispenser tip. As disclosed elsewhere herein, such a vial may contain a preparation such as a fluid medicament. The vial can be loaded into the interior chamber 1156.

FIG. 10E-1 is a perspective view of the rear, right, and top view of the vial tip of the single chamber mechanical dispenser shown in FIG. 10A, according to embodiments of the present invention. As illustrated in FIG. 10E-1, a dispenser tip 2000, which may also be referred to as a molded tip part or a vial tip, can be a single molded part, and may be made out of plastic for example. In some cases, dispenser tip 2000 can be provided as an assembly of two or more subcomponents. Dispenser tip 2000 includes a distal portion 2100 and a proximal portion 2200.

As depicted in FIG. 10E-1, dispenser tip 2000 can include a surface 620, which may be a tapered surface, that engages with a vial, so as to help form a leak-tight junction between the dispenser tip and the vial.

In some embodiments, dispenser tip 2000 can be configured so that surface 620 provides a surface that at least in part provides a liquid-tight or fluid-tight seal with a vial. In some cases, surface 620 can be configured for insertion into a distal aperture of a vial, as discussed elsewhere herein. In some cases, the distal aperture of the vial includes a tapered surface that is complementary (e.g. in a geometrical manner) to a taper of surface 620.

In some cases, dispenser tip may include an inside groove 630, which may be molded into a surface of the dispenser tip 2000. Inside groove 630 can be shaped or configured to mate to and against a molded rim of a vial. In some embodiments, inside groove 630 may be part of a snap-on cap 640 of dispenser tip 2000. Snap-on cap 640 may be configured or shaped to slip-over and lock onto a molded rim of a vial. When dispenser tip 2000 and a vial are joined together by the snap on mating of a molded rim of the vial, and the snap-on cap 640 of dispenser tip 2000, the resulting snap-on connection operates to hold pressure on the associated surfaces 620 of dispenser tip 2000, and an entry port or distal aperture of a vial. The pressure in turn can operate to maintain or help maintain a leak-tight seal of a cartridge subassembly, between the vial and the dispenser tip. As depicted in FIG. 10E-1, dispenser tip 2000 can also include a vial port opening 610.

According to some embodiments, when surface 620 and a corresponding surface of a vial distal aperture of entry port are mated and held together, they can form a leak-tight junction. In some embodiments, other leak-tight configurations can be provided whereby a dispenser tip and a vial are mated or otherwise engaged with one another.

FIG. 10E-2 is a perspective view of the front, right, and top view of the vial tip of the single chamber mechanical dispenser shown in FIG. 10A, according to embodiments of the present invention. As illustrated in FIG. 10E-2, a dispenser tip 3000 which may also be referred to as a molded tip part or a vial tip, can be a single molded part, and may be made out of plastic for example. In some cases, dispenser tip 3000 can be provided as an assembly of two or more subcomponents. Dispenser tip 3000 includes a distal portion 3100 and a proximal portion 3200. Distal portion 3100 of dispenser tip 3000 includes a nozzle 3110 having an exit port 3112.

According to some embodiments, during operation of a dispenser device, a fixed amount of preparation (e.g. fluid or liquid) exits out of the exit port 3112 of the dispenser tip 3000. As shown here, the exit port 3112 is provided as an aperture that is generally circular in shape. Embodiments of the present invention encompass other configurations of an exit port shape, including elliptical shapes, square shapes, rectangular shapes, and the like. As discussed elsewhere herein, a portion of the nozzle 3110 can extend distally from a vial holder when the dispenser device is in an assembled state, or when the dispenser tip 3000 is otherwise engaged or in contact with the vial holder. In some cases, the length of the nozzle 3110 section which protrudes or extends distally from and externally to the vial holder is about 100 mils (100 thousandths of an inch). According to some embodiments, dispenser tip 3000 is configured so that it does not mate with or accommodate a needle (e.g. tissue-piercing needle). In some cases, the exit port 3112 provides an opening that is of a smaller diameter than that necessary to mate with a needle. According to some embodiments, when a dispenser device is used to dispense a fluid or liquid, the fluid or liquid is expelled as a non-drip forming stream exiting the exit port 3112.

It is appreciated that dispenser tip or molded tip part 3000 can be manufactured using materials other than plastic, such as rubber, silicone, wood, metal, or even a fluoropolymer such as Teflon. It is also appreciated that the dispenser tip 3000, which may be provided as a single piece molded tip part, may be modified to consist of multiple pieces. By means of example, but not of limitation, the nozzle or dispensing end 3110 of the dispenser tip 3000 or molded tip part could be designed to be made of stainless steel or any other metal, thus increasing the durability of the nozzle 3110.

According to some embodiments, the instant application discloses an ornamental design for a dispenser as shown in FIGS. 10A to 10E-2. According to some embodiments, the instant application enables a claim for an ornamental design for a dispenser as shown in FIGS. 10A to 10E-2. According to some embodiments, the instant application discloses an ornamental design for a dispenser device as shown in FIGS. 10A to 10E-2. According to some embodiments, the instant application enables a claim for an ornamental design for a dispenser device as shown in FIGS. 10A to 10E-2.

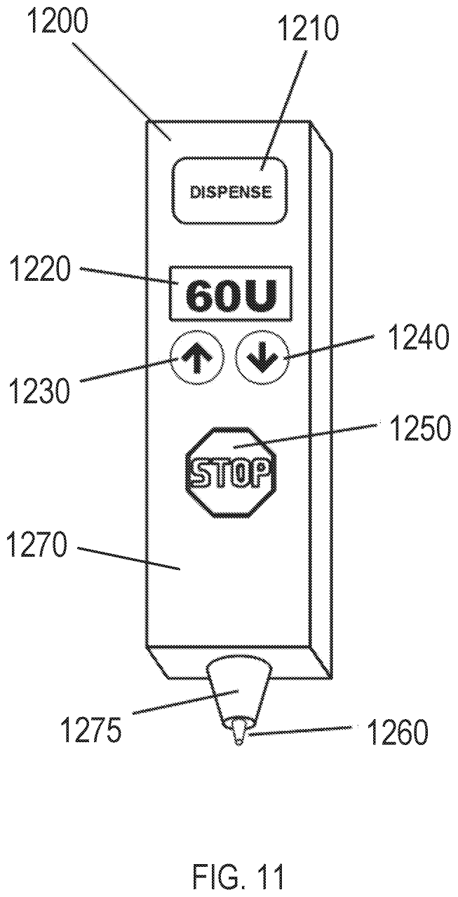

FIG. 11 depicts aspects of a dispenser device 1200 according to embodiments of the present invention. Dispenser device 1200 can include or incorporate an electronically-controlled mechanism for fixed-amount control and delivery of an amount of a preparation. Conveniently, dispenser device 1200 may be sized to be kept in a purse. Dispenser device 1200 can include a dispense button 1210 that can be used (e.g. actuated or depressed) by an operator to initiate dispensing of a fixed-amount of preparation or liquid once the fixed-amount amount is set by using local fixed-amount setting display 1220, or by a linked digital controller. Fixed-Amount selection buttons 1230 and 1240 can be used with local fixed amount selection display 1220, to set the fixed-amount. Stop button 1250 can be used to stop a fixed-amount while being dispensed, and to reset the dispenser device 1200. A cone 1275 of (or coupled with) a housing 1270 can be shaped to hold, receive, or otherwise engage an internal cartridge subassembly (e.g. cartridge assembly 700 depicted in FIG. 3). A distal portion of a cartridge subassembly (e.g. which may include an exit port of a dispenser tip 1260) can serve as a conduit through which an amount of preparation is dispensed from the dispenser device 1200.

In some embodiments, the overall size of the housing 1270 allows for an electric motor drive and electronic control system, possible with a microprocessor, to be part of or incorporated into the dispenser device 1200. In some embodiments, control circuitry of the dispenser device 1200 could incorporate radio circuitry or infra-red circuitry to establish a link to a digital controller. For example, but not by means of limitation, such digital controller could be a custom device, smartphone, a tablet, or a computer; and the associated communications may be direct, or thru the internet or other digital or analogue communications medium. In some embodiments, aspects of the dispenser device 1200, such as the housing 1270, can be configured for use with a stand (e.g. to be held by a stand). Relatedly, in some cases, the dispenser device 1200 can be supported by a stand, above a glass or mug, for use in the home or office.

In some cases, any of the dispenser device embodiments disclosed herein may include a biometric security feature (e.g. iris recognition mechanism, fingerprint recognition mechanism, voice recognition mechanism, and the like). Such features can be used in combination with an application software (e.g. mobile app) that can be used to secure the dispenser device, and/or to prevent the dispenser device from dispensing a preparation (e.g. medicament) to a person other than the patient or intended user.

FIGS. 12A-12G illustrate aspects of a viewing assembly 12150, according to embodiments of the present invention. In some cases, the terms “viewing assembly” and “vial holder” may be used interchangeably. In some cases, the viewing assembly 12150 depicted here may be referred to as a reusable viewing assembly or a reusable vial holder. In some cases, viewing assembly 12150 can be provided as a part of, or as a part for, a reusable dispenser device.

FIG. 12A is a top perspective view of a viewing assembly showing a new design. As shown here, a distal portion 12154 of the viewing assembly 12150 can include a tapered section 12151 which can operate to secure and limit the travel of a dispenser tip when the dispenser tip is received by or engaged with the viewing assembly 12150. In some embodiments, the tapered section 12151 narrows towards the dispensing or distal end of the dispenser device. In some cases, the tapered section 12151 (e.g. an interior conduit wall thereof) of the viewing assembly 12150 is formed and used to secure and limit the travel of the dispenser tip of the cartridge subassembly that is internal to the cartridge and housing assembly, and the vial is visible through the vial sight window 12152 (see, e.g. FIG. 12B). As illustrated in FIG. 12A, a viewing assembly 12150 (e.g. a vial holder) may include an aperture or window 12152. Viewing assembly 12150 includes an interior chamber 12156 that is configured to receive a vial and/or a dispenser tip. As disclosed elsewhere herein, such a vial may contain a preparation such as a fluid medicament. The vial can be loaded into the interior chamber 12156. As discussed elsewhere herein, tapered section 12151 can operate to secure and limit the travel of a dispenser tip when the dispenser tip is received by the viewing assembly 12150, and a distal nozzle of the dispenser tip extends distally through a distal aperture 12153 of the viewing assembly 12150. The liquid-exit port of dispenser tip can protrude through a narrowing of viewing assembly 12150, and is a visible component of the dispenser tip. When the pen is being stored, the dispenser tip can be protected from physical damage by a cap or cap assembly (not shown). A distal nozzle of the dispenser tip provides a conduit through which an amount of a preparation can be dispensed from the dispenser device. Once the dispenser tip is inserted and seated against a tapered section 12151 of viewing assembly or housing 12150 (e.g. of a cartridge and housing assembly), the distal nozzle can operate as the protruding part of a narrowed end of the dispenser tip that becomes the final dispensing feature of a dispenser device. With reference to FIGS. 5B, 8E-3, 8F-3, and 8G-3, it is understood that viewing assembly 12150 may include a viewing assembly coupling mechanism, such as a threaded section (see, e.g. threaded section 159A depicted in FIG. 5B), where the viewing assembly coupling mechanism is configured to secure or couple the viewing assembly 12150 with a control assembly. For example, the control assembly may have a corresponding threaded section this is configured to threadingly engage the threaded section of the viewing assembly (see, e.g. control assembly coupling mechanism 1137 depicted in FIG. 10A).

FIG. 12B is a front elevation view of a viewing assembly showing a new design. As shown here, viewing assembly 12150 can include a vial sight window 12152, as well as other elements depicted in FIG. 12A. In some cases, a viewing assembly 12150 may include one or more protruding tabs 12155 that operate to engage a cap. In this way, a cap can be snapped on to the viewing assembly 12150. For example, the cap may include indents or grooves that are configured to receive or otherwise engage one or more protruding tabs 12155 that are disposed on the viewing assembly 12150.

FIG. 12C is a rear elevation view of a viewing assembly showing a new design. As shown here, viewing assembly 12150 can include a vial sight window 12152, as well as other elements depicted in FIG. 12A.

FIG. 12D is a right side elevation view of a viewing assembly showing a new design. As shown here, viewing assembly 12150 can include a distal portion 12154 having a tapered section 12151, as well as other elements depicted in FIG. 12A.

FIG. 12E is a left side elevation view of a viewing assembly showing a new design. As shown here, viewing assembly 12150 can include a distal portion 12154 having a tapered section 12151, as well as other elements depicted in FIG. 12A.

FIG. 12F is a top plan view of a viewing assembly showing a new design. As shown here, viewing assembly 12150 can have a proximal flat surface 12157.

FIG. 12G is a bottom plan view of a viewing assembly showing a new design. As shown here, viewing assembly 12150 can distal aperture 12153.

According to some embodiments, the viewing assembly depicted in FIGS. 12A-12G is used with or is a component of a dispenser device. According to some embodiments, the viewing assembly depicted in FIGS. 12A-12G engages with a dispenser tip of a dispenser device. According to some embodiments, the instant application discloses an ornamental design for a viewing assembly as shown in FIGS. 12A-12G. According to some embodiments, the instant application enables a claim for an ornamental design for a viewing assembly as shown in FIGS. 12A-12G. According to some embodiments, the instant application discloses an ornamental design for a viewing assembly for a dispenser device as shown in FIGS. 12A-12G.

According to some embodiments, the instant application enables a claim for an ornamental design for a viewing assembly for a dispenser device as shown in FIGS. 12A-12G.

In some embodiments, FIGS. 12A-12G depict aspects of a design (e.g. an ornamental design) for a viewing assembly. Embodiments of the present invention encompass one or more ornamental designs or ornamental characteristics that are embodied in the viewing assembly depicted in FIGS. 12A-12G, and which may relate to the configuration or shape of the viewing assembly depicted in FIGS. 12A-12G. In some cases, the ornamental designs or characteristics may be embodied in the entire viewing assembly shown in FIGS. 12A-12G. In some cases, the ornamental designs or characteristics may be embodied in only a portion of or in certain features of the viewing assembly shown in FIGS. 12A-12G. The scope of the design is not defined or limited by the solid line structure depicted in FIGS. 12A-12G. Where the ornamental designs or characteristics are embodied in only a portion of or in certain features of the viewing assembly, it is understood that one or more portions of or certain features of the solid line structure depicted in FIGS. 12A-12G can be converted to or replaced with broken or dashed lines, whereby such broken or dashed lines may form no part of a claimed design, whereby such broken or dashed lines may represent a portion of the design that is unclaimed, and/or whereby such broken or dashed lines may include a portion of the viewing assembly in which the design is embodied, without resulting in a change in configuration of the design embodied in FIGS. 12A-12G. For example, but without limitation, it is understood that the tapered section of the design embodied in the viewing assembly depicted in FIGS. 12A-12G may be claimed separately from the remainder of the design. Embodiments of the present invention encompass one or more design claims directed to one or more subsets of the features or elements illustrated in FIGS. 12A-12G. Any broken or dashed lines present in FIGS. 12A-12G may be disclaimed portions of the viewing assembly as forming no part of a claimed design or a design to be patented. It is understood that one or more portions of or certain features of any broken or dashed lines depicted in FIGS. 12A-12G can be converted to or replaced with solid line structure, without resulting in a change in configuration of the design embodied in FIGS. 12A-12G.

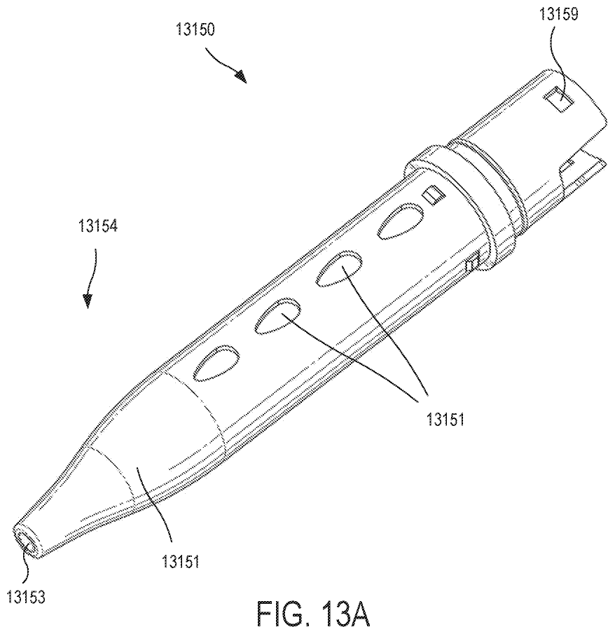

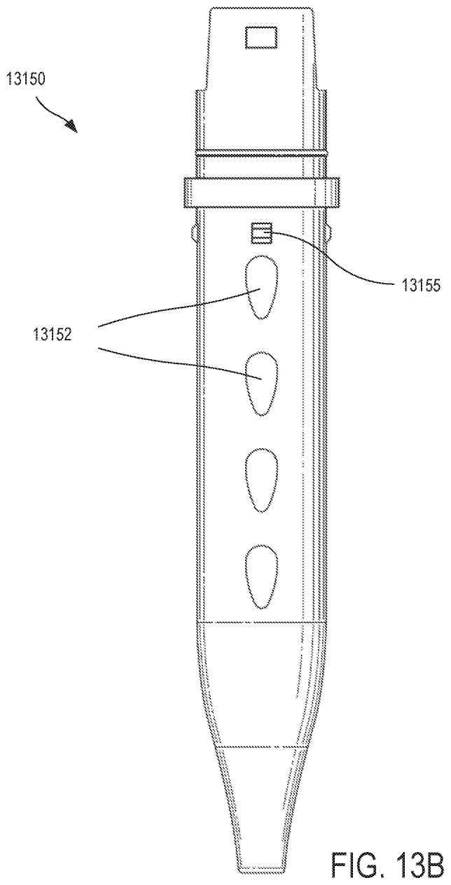

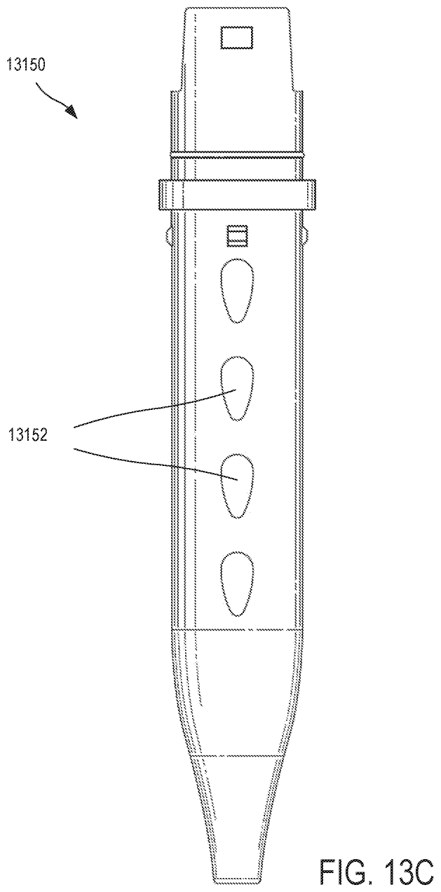

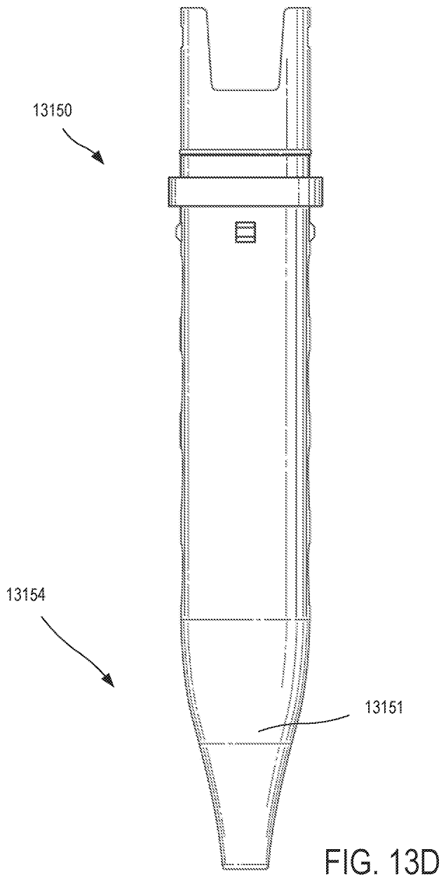

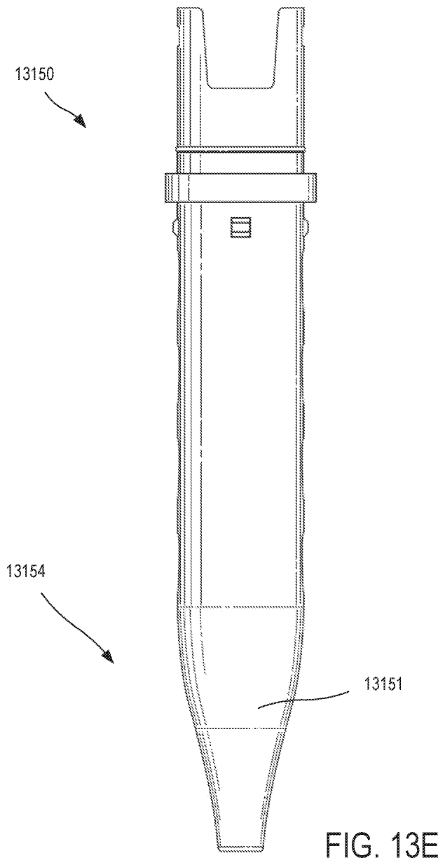

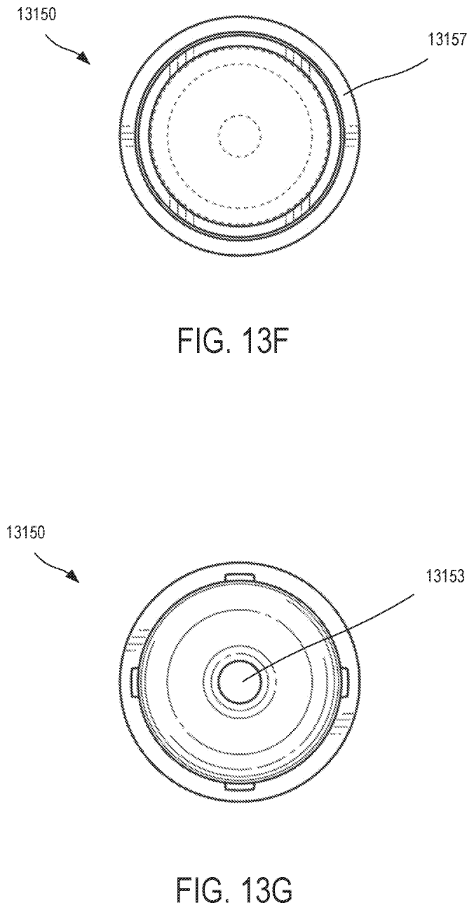

FIGS. 13A-13G illustrate aspects of a viewing assembly 13150, according to embodiments of the present invention. In some cases, the terms “viewing assembly” and “vial holder” may be used interchangeably. In some cases, the viewing assembly 13150 depicted here may be referred to as a disposable viewing assembly or a disposable vial holder. In some cases, viewing assembly 13150 can be provided as a part of, or as a part for, a disposable dispenser device.

FIG. 13A is a top perspective view of a viewing assembly showing a new design. As shown here, a distal portion 13154 of the viewing assembly 13150 can include a tapered section 13151 which can operate to secure and limit the travel of a dispenser tip when the dispenser tip is received by or engaged with the viewing assembly 13150. In some embodiments, the tapered section 13151 narrows towards the dispensing or distal end of the dispenser device. In some cases, the tapered section 13151 (e.g. an interior conduit wall thereof) of the viewing assembly 13150 is formed and used to secure and limit the travel of the dispenser tip of the cartridge subassembly that is internal to the cartridge and housing assembly, and the vial is visible through one or more vial sight windows 13152. As illustrated in FIG. 13A, a viewing assembly 13150 (e.g. a vial holder) may include an aperture or window 13152. Viewing assembly 13150 includes an interior chamber that is configured to receive a vial and/or a dispenser tip. As disclosed elsewhere herein, such a vial may contain a preparation such as a fluid medicament. The vial can be loaded into the interior chamber. As discussed elsewhere herein, tapered section 13151 can operate to secure and limit the travel of a dispenser tip when the dispenser tip is received by the viewing assembly 13150, and a distal nozzle of the dispenser tip extends distally through a distal aperture 13153 of the viewing assembly 13150. The liquid-exit port of dispenser tip can protrude through a narrowing of viewing assembly 13150, and is a visible component of the dispenser tip. When the pen is being stored, the dispenser tip can be protected from physical damage by a cap or cap assembly (not shown). A distal nozzle of the dispenser tip provides a conduit through which an amount of a preparation can be dispensed from the dispenser device. Once the dispenser tip is inserted and seated against a tapered section 13151 of viewing assembly or housing 13150 (e.g. of a cartridge and housing assembly), the distal nozzle can operate as the protruding part of a narrowed end of the dispenser tip that becomes the final dispensing feature of a dispenser device. With reference to FIGS. 2, 3, and 6, it is understood that viewing assembly 13150 may include a viewing assembly coupling mechanism 13159 such as one or more indents or apertures. Such indents or aperture 13159 of the viewing assembly coupling mechanism can be configured to receive or otherwise engage corresponding mount-locking tabs of a control assembly coupling mechanism.

FIG. 13B is a front elevation view of a viewing assembly showing a new design. As shown here, viewing assembly 13150 can include one or more vial sight windows 13152, as well as other elements depicted in FIG. 13A. In some cases, viewing assembly 13150 can include one or more elements of a viewing assembly depicted in FIG. 1, 2, 3, or 6. In some cases, a viewing assembly 13150 may include one or more protruding tabs 13155 that operate to engage a cap. In this way, a cap can be snapped on to the viewing assembly 13150. For example, the cap may include indents or grooves that are configured to receive or otherwise engage one or more protruding tabs 13155 that are disposed on the viewing assembly 13150.

FIG. 13C is a rear elevation view of a viewing assembly showing a new design. As shown here, viewing assembly 13150 can include one or more vial sight windows 13152, as well as other elements depicted in FIG. 13A. In some cases, viewing assembly 13150 can include one or more elements of a viewing assembly depicted in FIG. 1, 2, 3, or 6.

FIG. 13D is a right side elevation view of a viewing assembly showing a new design. As shown here, viewing assembly 13150 can include a distal portion 13154 having a tapered section 13151, as well as other elements depicted in FIG. 13A. In some cases, viewing assembly 13150 can include one or more elements of a viewing assembly depicted in FIG. 1, 2, 3, or 6.

FIG. 13E is a left side elevation view of a viewing assembly showing a new design. As shown here, viewing assembly 13150 can include a distal portion 13154 having a tapered section 13151, as well as other elements depicted in FIG. 13A. In some cases, viewing assembly 13150 can include one or more elements of a viewing assembly depicted in FIG. 1, 2, 3, or 6.

FIG. 13F is a top plan view of a viewing assembly showing a new design. As shown here, viewing assembly 13150 can have a proximal flat surface 13157. In some cases, viewing assembly 13150 can include one or more elements of a viewing assembly depicted in FIG. 1, 2, 3, or 6.

FIG. 13G is a bottom plan view of a viewing assembly showing a new design. As shown here, viewing assembly 13150 can distal aperture 13153. In some cases, viewing assembly 13150 can include one or more elements of a viewing assembly depicted in FIG. 1, 2, 3, or 6.

According to some embodiments, the viewing assembly depicted in FIGS. 13A-13G is used with or is a component of a dispenser device. According to some embodiments, the viewing assembly depicted in FIGS. 13A-13G engages with a dispenser tip of a dispenser device. According to some embodiments, the instant application discloses an ornamental design for a viewing assembly as shown in FIGS. 13A-13G. According to some embodiments, the instant application enables a claim for an ornamental design for a viewing assembly as shown in FIGS. 13A-13G. According to some embodiments, the instant application discloses an ornamental design for a viewing assembly for a dispenser device as shown in FIGS. 13A-13G. According to some embodiments, the instant application enables a claim for an ornamental design for a viewing assembly for a dispenser device as shown in FIGS. 13A-13G.

In some embodiments, FIGS. 13A-13G depict aspects of a design (e.g. an ornamental design) for a viewing assembly. Embodiments of the present invention encompass one or more ornamental designs or ornamental characteristics that are embodied in the viewing assembly depicted in FIGS. 13A-13G, and which may relate to the configuration or shape of the viewing assembly depicted in FIGS. 13A-13G. In some cases, the ornamental designs or characteristics may be embodied in the entire viewing assembly shown in FIGS. 13A-13G. In some cases, the ornamental designs or characteristics may be embodied in only a portion of or in certain features of the viewing assembly shown in FIGS. 13A-13G. The scope of the design is not defined or limited by the solid line structure depicted in FIGS. 13A-13G. Where the ornamental designs or characteristics are embodied in only a portion of or in certain features of the viewing assembly, it is understood that one or more portions of or certain features of the solid line structure depicted in FIGS. 13A-13G can be converted to or replaced with broken or dashed lines, whereby such broken or dashed lines may form no part of a claimed design, whereby such broken or dashed lines may represent a portion of the design that is unclaimed, and/or whereby such broken or dashed lines may include a portion of the viewing assembly in which the design is embodied, without resulting in a change in configuration of the design embodied in FIGS. 13A-13G. For example, but without limitation, it is understood that the tapered section of the design embodied in the viewing assembly depicted in FIGS. 13A-13G may be claimed separately from the remainder of the design. Embodiments of the present invention encompass one or more design claims directed to one or more subsets of the features or elements illustrated in FIGS. 13A-13G.

Any broken or dashed lines present in FIGS. 13A-13G may be disclaimed portions of the viewing assembly as forming no part of a claimed design or a design to be patented. It is understood that one or more portions of or certain features of any broken or dashed lines depicted in FIGS. 13A-13G can be converted to or replaced with solid line structure, without resulting in a change in configuration of the design embodied in FIGS. 13A-13G.

Cannabis and Other Preparations

As discussed elsewhere herein, a preparation (e.g. preparation 144 as depicted in FIG. 2) may be provided as a fluid. In some cases, preparation 144 may include a medicament. In some cases, preparation 144 may include a Cannabis oil, tincture, extract, and/or derivative. Device 100 may be configured to dispense any of a variety of preparations, such as fluids, gels, pastes, liquids, and other flowable materials. In some cases, a preparation 144 may include a whole plant Cannabis oil. In some cases, a preparation 144 may include a whole plant Cannabis tincture.

In exemplary embodiments, preparation 144 may include one or more substances derived from a Cannabis plant (e.g. Cannabis indica, Cannabis sativa, or Cannabis ruderalis). Derived substances may include cannabinoids, terpenes, and flavonoids. According to some embodiments, these, and other derivatives or compounds obtained from a Cannabis plant, may be referred to generically as Cannabis constituents.

Cannabinoids are a unique class of compounds associated with the Cannabis plant. According to some embodiments, Cannabis cannabinoids may include cannabichromenes such as cannabichromene (CBC), cannabichromenic acid (CBCA), cannabichromevarin (CBCV), and cannabichromevarinic acid (CBCVA). According to some embodiments, cannabinoids may include cannabicyclols such as cannabicyclol (CBL), cannabicyclolic acid (CBLA), and cannabicyclovarin (CBLV). According to some embodiments, cannabinoids may include cannabidiols such as cannabidiol (CBD), cannabidiol monomethylether (CBDM), cannabidiolic acid (CBDA), cannabidiorcol (CBD-C1), cannabidivarin (CBDV), and cannabidivarinic acid (CBDVA). According to some embodiments, cannabinoids may include cannabielsoins such as cannabielsoic acid B (CBEA-B), cannabielsoin (CBE), and cannabielsoin acid A (CBEA-A). According to some embodiments, cannabinoids may include cannabigerols such as cannabigerol (CBG), cannabigerol monomethylether (CBGM), cannabigerolic acid (CBGA), cannabigerolic acid monomethylether (CBGAM), cannabigerovarin (CBGV), and cannabigerovarinic acid (CBGVA). According to some embodiments, cannabinoids may include cannabinols and cannabinodiols such as cannabinodiol (CBND), cannabinodivarin (CBVD), cannabinol (CBN), cannabinol methylether (CBNM), cannabinol-C2 (CBN-C2), cannabinol-C4 (CBN-C4), cannabinolic acid (CBNA), cannabiorcool (CBN-C1),and cannabivarin (CBV). According to some embodiments, cannabinoids may include cannabitriols such as 10-Ethoxy-9-hydroxy-delta-6a-tetrahydrocannabinol, 8,9-Dihydroxy-delta-6a-tetrahydrocannabinol, cannabitriol (CBT), and cannabitriolvarin (CBTV). According to some embodiments, cannabinoids may include delta-8-tetrahydrocannabinols such as delta-8-tetrahydrocannabinol (Δ8-THC), and delta-8-tetrahydrocannabinolic acid (Δ8-THCA). According to some embodiments, cannabinoids may include delta-9-tetrahydrocannabinols such as delta-9-tetrahydrocannabinol (THC), delta-9-tetrahydrocannabinol-C4 (THC-C4), delta-9-tetrahydrocannabinolic acid A (THCA-A), delta-9-tetrahydrocannabinolic acid B (THCA-B), delta-9-tetrahydrocannabinolic acid-C4 (THCA-C4), delta-9-tetrahydrocannabiorcol (THC-C1), delta-9-tetrahydrocannabiorcolic acid (THCA-C1), delta-9-tetrahydrocannabivarin (THCV), and delta-9-tetrahydrocannabivarinic acid (THCVA). According to some embodiments, cannabinoids may include other cannabinoids such as 10-Oxo-delta-6a-tetrahydrocannabinol (OTHC), cannabichromanon (CBCF), cannabifuran (CBF), cannabiglendol, cannabiripsol (CBR), cannabicitran (CBT), dehydrocannabifuran (DCBF), delta-9-cis-tetrahydrocannabinol (cis-THC), tryhydroxy-delta-9-tetrahydrocannabinol (triOH-THC), and 3,4,5,6-Tetrahydro-7-hydroxy-alpha-alpha-2-trimethyl-9-n-propyl-2,6-methano-2H-1-benzoxocin-5-methanol (OH-iso-HHCV). In some cases, certain cannabinoids obtained from raw or live Cannabis can be converted by a decarboxylation process to provide different cannabinoids. For example, tetrahydrocannabinolic acid (THCA) obtained from raw or live Cannabis can be converted by a decarboxylation process to provide tetrahydrocannabinol (THC). Similarly, cannabidiolic acid (CBDA) obtained from raw or live Cannabis can be converted by a decarboxylation process to provide cannabidiol (CBD).

Terpenes are aromatic compounds associated with the Cannabis plant. According to some embodiments, Cannabis terpenes may include myrcene, linalool, pinene, limonene, β-caryophyllene, α-humulene, ocimene, terpinolene, geraniol, terpineol, valencene, phellandrene, carene, fenchol, terpinene, borneol, bisabolol, camphene, phytol, camphor, sabinene, isoborneol, menthol, nerolidol, cedrane, isopulegol, cymene, pulegone, eucalyptol, geranyl acetate, and guaiol.

Flavonoids are secondary metabolites associated with the Cannabis plant. According to some embodiments, Cannabis flavonoids may include cannflavine A, cannflavine B, cannflavine C, vitexin, isovitexin, apigenin, kaempferol, quercetin, luteolin, and orientin.

THC is probably best known for being the main psychoactive ingredient in Cannabis. CBD, however, is generally considered to be non-psychoactive. In some cases, it may be desirable to provide a user or consumer with a particular combination of Cannabis constituents within a preparation. For example, it may be desirable to provide a user or consumer with a preparation having a CBD:THC ratio of 1:1. In other instances, it may be desirable to provide a user or consumer with a preparation having a CBD:THC ratio of 10:1. Embodiments of the present invention encompass preparations having any desired ratio and/or combination of Cannabis constituents.

Consumers, patients, and other individuals may prefer and/or require individual Cannabis constituents (e.g. cannabinoid, terpene, and/or flavonoid compounds) to be delivered in a specific relationship with each other in order to administer a desired dose.

In some cases, a preparation may include an active ingredient, such as a botanical active ingredient. In some cases, a preparation may include an inactive ingredient. In some cases, a preparation may include a cannabinoid. In some cases, a preparation may include one or more of: cetirizine, ibuprofen, naproxen, omeprazole, doxylamine, diphenhydramine, melatonin, or meclizine. In some cases, a preparation may include one or more of: a polyphonel, short chain fatty acids, medium chain fatty acids, long chain fatty acids, a green tea catechin, caffeine, a phenol, a glycoside, a labdane diterpenoid, yohimbine, a proanthocyanidin, terpene glycoside, an omega fatty acid, echinacoside, an alkaloid, isovaleric acid, a terpene, gamma-aminobutyric acid, a senna glycoside, cinnamaldehyde, or any vitamin such as Vitamin D.

According to some embodiments, a preparation may include a Cannabis infusion, such as an extract obtained by soaking the leaves or other parts of a Cannabis plant in a liquid. In some cases, a preparation may include a water soluble liquid compound that is a cannabinoid oil or a terpene. Typically, cannabinoids (e.g. CBD, THC, and the like) are hydrophobic substances. Cannabinoids can, however, be formulated to be water-compatible and appear water-soluble. For example, CBD, THC, and other oils can be made water-compatible if they are formulated as oil-in-water nanoemulsions, which are stable and visually homogeneous oil/water mixtures. Nanoemulsions can be prepared in concentrated forms (e.g. tens of mg/ml) that are fully miscible with water and, therefore, appear water-soluble. In addition, nanoemulsions can be made translucent and practically tasteless, which means that they can be mixed into water without compromising its optical clarity or taste. According to some embodiments, nanoemulsions can be beneficial because they can be easily mixed into beverages, translucent, low-taste, and safe for consumption. Nanoemulsions can also provide exceptionally high bioavailability, fast onset of action, stable blood levels and high CBD/THC loading capacities. Embodiments of the present invention encompass mechanical dispensing devices used in combination with nanoemulsion technology to provide a precise, high water soluble, and bioavailable product for the oral consumption of constituents such as Cannabis oils.

As discussed elsewhere herein, a preparation (e.g. preparation 144 as depicted in FIG. 2) may be provided as a fluid. In some cases, preparation 144 may include a medicament. In some cases, preparation 144 may include one or more substances derived from a plant or fungi. In some cases, preparation 144 may include one or more substances derived from a Psilocybe fungi (e.g. Psilocybe cubensis, Psilocybe azurescens, Psilocybe caerulescens, Psilocybe mexicana, Psilocybe quebecensis, Psilocybe baeocystis, Psilocybe cyanescens, Psilocybe semilanceata, and the like). Derived substances may include Psilocybin (4-phosphoryloxy-N,N-dimethyltryptamine), Psilocin (4-hydroxy-N,N-dimethyltryptamine), Baeocystin (4-phosphoryloxy-N-methyltryptamine), Norbaeocystin (4-phosphoryloxytryptamine), Norpsilocin, Aerugunosin, and the like. According to some embodiments, these, and other derivatives or compounds obtained from a Psilocybe organism, may be referred to generically as Psilocybe constituents. Likewise, a preparation 144 may include one or more substances or constituents derived from other psilocybin containing mushrooms, including fungi from the genera of Copelandia, Gymnopilus, Inocybe, Panaeolus, Pholiotina, and Pluteus. In some cases, a preparation 144 may include lysergic acid diethylamide (LSD). In some cases, a preparation 144 may include 3,4-methylenedioxymethamphetamine (MDMA). In some cases, a preparation 144 may include ketamine. In some cases, a preparation 144 may include one or more psychoactive alkaloids, including indole alkaloids. In some cases, preparation 144 may include one or more substances derived from Anadenanthera colubrina or Anadenanthera peregrina. In some cases, a preparation may include any compound, substance, or chemical which is believed to be useful in treating individuals having or susceptible to depression, anxiety, and posttraumatic stress disorder (PTSD). In some cases, a preparation 144 may include one or more materials, chemicals, or compounds selected from the group consisting of a monoamine oxidase inhibitor, dimethyltryptamine, ibogaine, salvinorin A, salvinorin B, 3,4,5-trimethoxyphenethylamine (mescaline), bufotenine, 5-methoxy-N,N-dimethyltryptamine (5-MeO-DMT), mesembrine, mesembrenone, mesembrenol, tortuosamine, muscimol, muscarine, muscazone, ibotenic acid, and 5-bromo-N,N-dimethyltryptamine (5-Bromo-DMT). A monoamine oxidase (MAO) inhibitor may include a β-carboline. A monoamine oxidase (MAO) inhibitor may include a nonselective MAO-A/MAO-B inhibitor, a selective MAO-A inhibitor, a selective MAO-B inhibitor, or a reversible inhibitors of monoamine oxidase A (RIMA). RIMAs are a subclass of MAO inhibitors that selectively and reversibly inhibit the MAO-A enzyme. Exemplary nonselective MAO-A/MAO-B inhibitors include hydrazines such as isocarboxazid, nialamide, phenelzine, and hydracarbazine, as well as non-hydrazines such as tranylcypromine. Selective MAO-A inhibitors include bifemelane, moclobemide, pirlindole, and toloxatone. Selective MAO-B inhibitors include rasagiline, selegiline, and safinamide. Reversible inhibitors of monoamine oxidase A include brofaromine, caroxazone, eprobemide, Methylene blue, metralindole, minaprine, moclobemide, pirlindole, toloxatone, curcumin, harmaline, and harmine. In some cases, a preparation 144 may include one or more materials, chemicals, or compounds described in any one or more of U.S. Pat. No. 3,075,992 (Hofmann), U.S. Pat. No. 3,183,172 (Heim et al.), U.S. Pat. No. 3,192,111 (Hofmann et al.), and/or US Patent Publication Nos. 2018/0021326 (Stamets), 2018/0221396 (Chadeayne), 2019/0105313 (Stamets), 2019/0119310 (Londesbrough et al.), 2019/0142851 (Chadeayne), and/or 2019/0350949 (Kucuksen et al.). The content of each of the above patent filings is incorporated herein by reference.

Micro-Dosing

According to some embodiments, it may be desirable to precisely control the amount of one or more Cannabis constituents, or other compounds or molecules, that are being dispensed from a dispensing device. Embodiments of the present invention enable the user or individual to precisely vary or control the quantity of cannabinoids (or other compounds or molecules) that are dispensed from a dispensing device. For example, the quantity of a preparation or fluid that is dispensed from a dispensing device may be varied by changing the dose settings of the dispensing device. The user or healthcare professional may then select the most appropriate micro-dosing quantity for a particular treatment regime. The ability to control the dose of one cannabinoid (such as THC) to a custom level or mixture of cannabinoids (such as CBD) may give the healthcare professionals and users the flexibility to titrate the Cannabis constituents and/or other compounds or molecules upward or downward with more precision. In this way, for example through an iterative process, the user or individual is able to discover a minimum amount or dosage of a Cannabis preparation that provides the desired result.

According to some embodiments, the micro-dosing of Cannabis constituents involves taking a very measured micro-dose of THC, which is typically considered to be a psychoactive ingredient in Cannabis, and a measured dose of CBD, which is typically considered to be a non-psychoactive ingredient in Cannabis. Toward this end, vials containing Cannabis preparations can be provided which contain known amounts, ratios, and/or concentrations of Cannabis constituents. For example, a vial may contain 3 ml of a preparation that contains THC at a concentration of 25 mg/ml and CBD at a concentration of 100 mg/ml. When a dispensing device is used to dispense 0.20 ml (milliliter) of the preparation (e.g. 20 clicks), the user or individual will know that the dispensed amount contains 5 mg of THC and 20 mg of CBD. In some cases, vials or vial assemblies can be provided as pre-mixed or pre-prepared vial assemblies. According to some embodiments, vials can be prepared so as to contain one or more Cannabis constituents, in any desired combination, in any desired amount or ratio of amounts.

Because precise micro-dose amounts can be accurately dispensed using the dispensing devices and methods as disclosed herein, it is possible for users or individuals to obtain the desired dosage in an economical fashion while also minimizing waste and avoiding inadvertent or unwanted overdosing of the Cannabis constituents and/or other compounds or molecules.

Embodiments of the present invention are well suited for use in delivering a dose or an amount of a preparation for consumption by an individual or user. Any aspect of the preparation, including for example the concentration or amount of one or more Cannabis constituents contained therein, can be designed as desire. In some cases, the formulation and/or amount of the preparation to be consumed is based on a therapeutic relationship amongst one or more components of the preparation. In some case, a therapeutic relationship can be determined between individual cannabinoid compounds, and a dispenser device can help ensure that a patient/user receives an optimum therapeutic dose without the inherent risks associated with bottle droppers, smoking, vaping, or edibles. In some cases, a preparation may include one or more cannabinoids and/or terpenes present in water soluble fluids that make it easy to dispense, dissolve, and mix into beverage of choice.

Table 1 below illustrates the operability of exemplary dispenser device configurations, according to embodiments of the present invention.

TABLE 1

| Vial | THC | Turn Dosage |
|---|---|---|
| ml | mg | Knob Clicks |
| 3 | 30 | 300 |
| 1 | 10 | 100 |
| 0.1 | 1 | 10 |
| 0.05 | 0.05 | 5 |

In some cases, a control assembly can include a clicking mechanism, which is configured to provide the user with audible and/or tactile feedback, to assist the user in controlling how much preparation is dispensed with each click. In some cases, a dispenser device is configured to dispense 1/100 of milliliter of preparation per click. In some cases, a dispenser device is configured to dispense less than a drop (e.g. a droplet) of preparation per click. In some cases, a dispenser device is configured to dispense the contents of a vial upon actuation of 100 clicks. In some cases, a dosage amount of 2.5 mg or less of Cannabis constituent is considered to be a micro-dose. In some cases, a dosage amount on the order of micrograms is considered to be an ultra-micro-dose.

In some cases, a dispenser device can include or be used with a 3 ml vial filled with a Cannabis extraction oil formulated for oral and sublingual dosing. In some cases, a vial may include 90 mg of active cannabinoids, optionally infused with terpenes and/or nutraceuticals, to provide an entourage effect. Micro-dosing embodiments disclosed herein may be used by individuals having various conditions, including depression, stress, anxiety, pain, and the like. Micro-dosing embodiments disclosed herein may be used by individuals seeking improved mental focus and/or sleeping patterns. As described elsewhere herein, a vial may contain 3 ml of a preparation that contains cannabinoid content at a concentration of 25 mg/ml or 100 mg/ml, for example. In some cases, a vial may contain 3 ml of oil and 100 mg THC. In some cases, a vial may contain a cannabinoid concentration of about 100 mg per 3 ml of oil or other carrier. In some cases, a vial may contain a cannabinoid concentration of about 100 mg per ml of oil or other carrier. In some cases, a vial may contain a cannabinoid concentration having a value within a range from about 0.3 mg per ml of carrier to about 500 mg per ml of carrier. In some cases, a vial may include cannabinoid content having within a range of about 1 mg to about 1500 mg. In some cases, the cannabinoid content includes active cannabinoids. In some cases, the cannabinoid content contained within a vial may have a value of about 1.5 ml, or less. In some cases, a 3 ml vial may include 1.5 ml of cannabinoids, and 1.5 ml of carrier or blending oil, which may be olive oil or medium-chain triglyceride (MCT) oil.

In the Summary above and in this Detailed Description, and the claims below, and in the accompanying drawings, reference is made to particular features of embodiments of the present invention. It is to be understood that the disclosure of the embodiments of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “at least” followed by a number is used herein to denote the start of a range including that number (which may be a range having an upper limit or no upper limit, depending on the variable being defined). For example, “at least 1” means 1 or more than 1. The term “at most” followed by a number is used herein to denote the end of a range, including that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limits include both numbers. For example, “25 to 100” means a range whose lower limit is 25 and upper limit is 100, and includes both 25 and 100.

Although the preceding description contains significant detail in relation to the preferred embodiment, it should not be construed as limiting the scope of the invention but rather as providing illustrations of the preferred embodiments.

All features of the described systems and devices are applicable to the described methods Mutatis mutandis, and vice versa. Embodiments of the present invention encompass kits having child-resistant safety container systems as disclosed herein. In some embodiments, the kit includes one or more container systems, along with instructions for using the system for example according to any of the methods disclosed herein.

Although the foregoing invention has been described in some detail by way of illustration and example for purposes of clarity of understanding, one of skill in the art will appreciate that certain changes, modifications, alternate constructions, and/or equivalents may be practiced or employed as desired, and within the scope of the appended claims. In addition, each reference provided herein in incorporated by reference in its entirety to the same extent as if each reference was individually incorporated by reference. Relatedly, all publications, patents, patent applications, journal articles, books, technical references, and the like mentioned in this specification are herein incorporated by reference to the same extent as if each individual publication, patent, patent application, journal article, book, technical reference, or the like was specifically and individually indicated to be incorporated by reference.

What is claimed is:

1. A dispenser device, comprising:
a vial assembly having a vial, a stopper, and a preparation, wherein the stopper and the preparation are disposed within the vial, and wherein the vial includes a proximal portion and a distal portion;
a dispenser tip having a proximal portion and a distal portion, wherein the proximal portion of the dispenser tip is engaged with the distal portion of the vial;
a viewing assembly having a viewing assembly coupling mechanism;
a control assembly having control assembly coupling mechanism and a dosage knob, wherein the control assembly coupling mechanism is coupled with the viewing assembly coupling mechanism, and wherein the dosage knob is configured to set a desired dosage amount of the preparation for dispensing by the dispenser device; and
a cap configured to releasably attach with the viewing assembly,
wherein the proximal portion of the vial contacts the control assembly at a first contact location, wherein the distal portion of the dispenser tip contacts the viewing assembly at a second contact location, wherein compression created at the first contact location and the second contact location due to engagement between the control assembly and the viewing assembly inhibits disengagement between the proximal portion of the dispenser tip and the distal portion of the vial, wherein the distal portion of the vial comprises a rim having an outer surface, an inner surface, a distal surface disposed between the outer surface and the inner surface, and a distal aperture, wherein the proximal portion of the dispenser tip comprises a flange proximal portion inner surface, a proximal shaft having a proximal shaft surface, and a flange distal portion inner surface disposed between the flange proximal portion inner surface and the proximal shaft surface, wherein the outer surface of the rim of the vial is apposed to the flange proximal portion inner surface of the proximal portion of the dispenser tip, wherein the inner surface of the rim of the vial is apposed to the proximal shaft surface of the proximal portion of the dispenser tip, wherein the distal surface of the rim of the vial is apposed to the flange distal portion inner surface of the proximal portion of the dispenser tip, and wherein the distal aperture of the rim of the vial is configured to receive the proximal shaft of the dispenser tip.

2. The dispenser device according to claim 1, wherein the proximal portion of the dispenser tip comprises a proximal body surface, wherein the distal portion of the dispenser tip comprises a distal nozzle surface, wherein the dispenser tip comprises a distal shaft surface disposed between the proximal body surface and the distal nozzle surface, and wherein a circumference of the distal shaft surface is less than a circumference of the proximal body surface and greater than a circumference of the distal nozzle surface.

3. A dispenser device, comprising:
a vial assembly having a vial, a stopper, and a preparation, wherein the stopper and the preparation are disposed within the vial, and wherein the vial includes a proximal portion and a distal portion;
a dispenser tip having a proximal portion and a distal portion, wherein the proximal portion of the dispenser tip is engaged with the distal portion of the vial and an interference fit is present between the proximal portion of the dispenser tip and the distal portion of the vial;
a viewing assembly having a viewing assembly coupling mechanism;
a control assembly having control assembly coupling mechanism and a dosage knob, wherein the control assembly coupling mechanism is coupled with the viewing assembly coupling mechanism, and wherein the dosage knob is configured to set a desired dosage amount of the preparation for dispensing by the dispenser device; and
a cap configured to releasably attach with the viewing assembly,
wherein the proximal portion of the vial contacts the control assembly at a first contact location, wherein the distal portion of the dispenser tip contacts the viewing assembly at a second contact location, wherein compression created at the first contact location and the second contact location due to engagement between the control assembly and the viewing assembly inhibits disengagement between the proximal portion of the dispenser tip and the distal portion of the vial, wherein the distal portion of the vial comprises a rim, wherein the proximal portion of the dispenser tip comprises a groove defined at least in part by a flange of the proximal portion of the dispenser tip and a proximal shaft of the proximal portion of the dispenser tip, wherein the rim of the distal portion of the vial is received by the groove of the proximal portion of the dispenser tip, wherein the flange has a proximal portion with a proximal edge, wherein the proximal shaft has a proximal edge, and wherein the proximal edge of the proximal shaft is disposed proximal to the proximal edge of the proximal portion of the flange.

4. A dispenser device, comprising:
a vial assembly having a vial, a stopper, and a preparation, wherein the stopper and the preparation are disposed within the vial, and wherein the vial includes a proximal portion and a distal portion;
a dispenser tip having a proximal portion and a distal portion, wherein the proximal portion of the dispenser tip is engaged with the distal portion of the vial;
a viewing assembly having a viewing assembly coupling mechanism;
a control assembly having control assembly coupling mechanism and a dosage knob, wherein the control assembly coupling mechanism is coupled with the viewing assembly coupling mechanism, and wherein the dosage knob is configured to set a desired dosage amount of the preparation for dispensing by the dispenser device; and
a cap configured to releasably attach with the viewing assembly,
wherein the proximal portion of the vial contacts the control assembly at a first contact location, wherein the distal portion of the dispenser tip contacts the viewing assembly at a second contact location, and wherein compression created at the first contact location and the second contact location due to engagement between the control assembly and the viewing assembly inhibits disengagement between the proximal portion of the dispenser tip and the distal portion of the vial.

5. The dispenser device according to claim 4, wherein the distal portion of the vial comprises a rim, wherein the proximal portion of the dispenser tip comprises a groove, and wherein the rim of the distal portion of the vial is received by the groove of the proximal portion of the dispenser tip.

6. The dispenser device according to claim 4, wherein the distal portion of the vial comprises a rim having an outer surface, wherein the proximal portion of the dispenser tip comprises a flange proximal portion inner surface, and wherein the outer surface of the rim of the vial is apposed to the flange proximal portion inner surface of the proximal portion of the dispenser tip.

7. The dispenser device according to claim 4, wherein the distal portion of the vial comprises a rim having an inner surface, wherein the proximal portion of the dispenser tip comprises a proximal shaft surface, and wherein the inner surface of the rim of the vial is apposed to the proximal shaft surface of the proximal portion of the dispenser tip.

8. The dispenser device according to claim 4, wherein the distal portion of the vial comprises a rim having a distal surface, wherein the proximal portion of the dispenser tip comprises a flange distal portion inner surface, and wherein the distal surface of the rim of the vial is apposed to the flange distal portion inner surface of the proximal portion of the dispenser tip.

9. The dispenser device according to claim 4, wherein the distal portion of the vial comprises a rim having a distal aperture, wherein the proximal portion of the dispenser tip comprises a proximal shaft, and wherein the distal aperture of the rim of the vial is configured to receive the proximal shaft of the dispenser tip.

10. The dispenser device according to claim 4, wherein the proximal portion of the dispenser tip comprises a proximal shaft having a vial port opening, wherein the distal portion of the dispenser tip comprises a distal nozzle having a distal exit port, and wherein the vial port opening of the proximal shaft of the proximal portion of the dispenser tip is in fluid communication with the distal exit port of the distal nozzle of the distal portion of the dispenser tip.

11. The dispenser device according to claim 4, wherein the proximal portion of the dispenser tip comprises a proximal body surface, wherein the distal portion of the dispenser tip comprises a distal nozzle surface, wherein the dispenser tip comprises a distal shaft surface disposed between the proximal body surface and the distal nozzle surface, and wherein a circumference of the distal shaft surface is less than a circumference of the proximal body surface and greater than a circumference of the distal nozzle surface.

12. The dispenser device according to claim 11, wherein the dispenser tip comprises a transition surface disposed between the distal nozzle surface and the distal shaft surface.

13. The dispenser device according to claim 4, wherein the proximal portion of the dispenser tip comprises a flange having a proximal portion with a proximal edge, wherein the proximal portion of the dispenser tip comprises a proximal shaft having a proximal edge, and wherein the proximal edge of the proximal shaft is disposed proximal to the proximal edge of the proximal portion of the flange.

14. The dispenser device according to claim 13, wherein a diameter of the proximal edge of the proximal shaft is less than a diameter of the proximal edge of the proximal portion of the flange.

15. The dispenser device according to claim 4, wherein the proximal portion of the dispenser tip comprises a proximal port, wherein the distal portion of the dispenser tip comprises a distal port, and wherein the dispenser tip comprises a central longitudinal conduit extending between the proximal port of the proximal portion of the dispenser tip and the distal port of the distal portion of the dispenser tip.

16. The dispenser device according to claim 15, wherein an inner diameter of the distal port of the distal portion of the dispenser tip is less than an inner diameter of the proximal port of the proximal portion of the dispenser tip.

17. The dispenser device according to claim 4, wherein the distal portion of the dispenser tip comprises a distal nozzle, wherein the viewing assembly comprises a distal aperture, and wherein the distal nozzle of the dispenser tip extends distally through the distal aperture of the viewing assembly.

18. The dispenser device according to claim 4, wherein the viewing assembly coupling mechanism comprises a threaded section, wherein the control assembly coupling mechanism comprises a threaded section, and wherein the threaded section of the viewing assembly coupling mechanism is configured to threadingly engage the threaded section of the control assembly coupling mechanism.

19. The dispenser device according to claim 4, wherein the viewing assembly coupling mechanism comprises an aperture, the control assembly coupling mechanism comprises a tab, and the aperture of the viewing assembly coupling mechanism is configured to receive the tab of the control assembly coupling mechanism.

20. The dispenser device according to claim 4, wherein the viewing assembly comprises one or more sight windows.
